(19) United States
(12) Patent Application Publication
(10) Pub. No.: US 2019/0334734 A1
(43) Pub. Date: Oct. 31, 2019

(54) Using Audio Components In Electrical Devices To Enable Smart Devices

(71) Applicant: Eaton Intelligent Power Limited, Dublin (IE)

(72) Inventors: Amir Marandi, Dacula, GA (US); Pengseng Tan, Peachtree City, GA (US); John Edward Bowen, Sharpsburg, GA (US); Bryant A. Bilal, Atlanta, GA (US); Jyoti Kumar, Tyrone, GA (US)

(21) Appl. No.: 16/168,555

(22) Filed: Oct. 23, 2018

Related U.S. Application Data
(60) Provisional application No. 62/662,868, filed on Apr. 26, 2018.

(51) Int. Cl. H04L 12/28; G10L 15/26; G10L 15/30

(52) U.S. Cl. CPC H04L 12/282; H04L 2012/2841; G10L 15/30; G10L 15/265

(57) ABSTRACT

A system can include a first electrical device, a network manager, and at least one second electrical device. The first electrical device includes at least one electrical device component used to operate the first electrical device to perform a function for which the first electrical device is designed to perform. The first electrical device can also include a sound-controlled system integrated with the first electrical device. The sound-controlled system can include at least one audio component integrated with the first electrical device, and a controller communicably coupled to the at least one audio component. The at least one audio component can capture a sound that enables the controller independent of the function performed by at least one electrical device component. The first controller can send the first sound to the network manager. The network manager can control the at least one second electrical device based on the first sound.

### CROSS REFERENCE TO RELATED APPLICATIONS

This application claims priority under 35 U.S.C. § 119 to U.S. Provisional Patent Application Ser. No. 62/662,868, titled “Using Audio Components In Electrical Devices To Enable Smart Devices” and filed on Apr. 26, 2018, the entire content of which is incorporated herein by reference.

### TECHNICAL FIELD

Embodiments described herein relate generally to electrical devices, and more particularly to systems, methods, and devices for using audio components in electrical devices to enable smart devices.

### BACKGROUND

Smart devices are continually evolving. For example, sound-controlled devices are a type of smart device that are becoming increasingly popular and sophisticated. These sound-controlled devices can directly respond to voice inquiries from a user, control other devices (e.g., lighting, thermostat settings), perform actions (e.g., set a calendar reminder, make dinner reservations), and perform other functions. These sound-controlled devices are currently stand-alone devices.

### SUMMARY

In general, in one aspect, the disclosure relates to a system that includes a first electrical device. The first electrical device can include at least one electrical device component used to operate the first electrical device to perform a function for which the first electrical device is designed to perform. The first electrical device can also include a sound-controlled system integrated with the first electrical device. The sound-controlled system can include at least one first audio component integrated with the first electrical device, and a controller communicably coupled to the at least one first audio component. The system can also include a network manager communicably coupled to the sound-controlled system. The system can further include at least one second electrical device coupled to the network manager. The at least one first audio component can capture a first sound. The at least one first audio component can send the first sound to the controller, where the first sound, when received by the controller, enables the first controller. The controller can be enabled independent of the function performed by at least one electrical device component. The controller can send, using a first communication mode, the first sound to the network manager. The network manager can control the at least one second electrical device based on the first sound.

In another aspect, the disclosure can generally relate to a system that includes an electrical device having at least one electrical device component used to operate the electrical device to perform a function for which the electrical device is designed to perform. The electrical device can also include a sound-controlled system integrated with the electrical device. The sound-controlled system can include at least one audio component integrated with the electrical device, and a controller communicably coupled to the at least one audio component. The system can also include a control device coupled to the electrical device, where the control device includes a first control mechanism, where operating the first control mechanism controls the function performed by the at least one electrical device without affecting operation of the sound-controlled system.

In another aspect, the disclosure can generally relate to a control device that includes a first control mechanism having at least two positions, where the first control mechanism is configured to be coupled to at least one first electrical device component of an electrical device, where the at least one first electrical device component is used to perform a first function for which the electrical device is designed to perform. The electrical device, when coupled to the first control mechanism, can further include at least one second electrical device component that performs a second function that is unrelated to the first function. Operating the first control mechanism between the at least two positions can control the first function performed by the at least one first electrical device component without affecting the second function performed by the at least one second electrical device component.

These and other aspects, objects, features, and embodiments will be apparent from the following description and the appended claims.

### BRIEF DESCRIPTION OF THE DRAWINGS

The drawings illustrate only example embodiments of using audio components in electrical devices to enable smart devices and are therefore not to be considered limiting of its scope, as using audio components in electrical devices to enable smart devices may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a diagram of a system that includes an electrical device in accordance with certain example embodiments.

FIG. 2 shows a computing device in accordance with certain example embodiments.

FIGS. 3A-3C show an electrical device in accordance with certain example embodiments.

FIG. 4 shows a system of multiple electrical devices in accordance with certain example embodiments.

FIGS. 5A and 5B show another electrical device in accordance with certain example embodiments.

FIGS. 6A and 6B show yet another electrical device in accordance with certain example embodiments.

FIG. 7 shows still another electrical device in accordance with certain example embodiments.

FIG. 8 shows yet another electrical device in accordance with certain example embodiments.

FIG. 9 shows still another electrical device in accordance with certain example embodiments.

FIG. 10 shows yet another electrical device in accordance with certain example embodiments.

FIG. 11 shows still another electrical device in accordance with certain example embodiments.

FIG. 12 shows yet another electrical device in accordance with certain example embodiments.

FIG. 13 shows still another electrical device in accordance with certain example embodiments.

FIG. 14 shows a diagram of another system that includes an electrical device in accordance with certain example embodiments.

FIG. 15 shows a control device in accordance with certain example embodiments.

FIG. 16 shows a system diagram of yet another system that includes an electrical device in accordance with certain example embodiments.

FIG. 17 shows a system in which an electrical device in accordance with certain example embodiments can be used.

### DETAILED DESCRIPTION OF EXAMPLE EMBODIMENTS

The example embodiments discussed herein are directed to systems, methods, and devices for using audio components in electrical devices to enable smart devices. While example embodiments are described herein as using audio components in light fixtures (also called luminaires herein) to enable smart devices, example embodiments can use audio components in one or more of a number of other electrical devices in addition to, or as an alternative to, light fixtures. Such other electrical devices can include, but are not limited to, a light switch, a control panel, a wall outlet, a smoke detector, a CO₂ monitor, a motion detector, a broken glass sensor, a smart device (e.g., a sound-controlled device), and a camera.

Example embodiments can be used for a volume of space having any size and/or located in any environment (e.g., indoors, outdoors, hazardous, non-hazardous, high humidity, low temperature, corrosive, sterile, high vibration). Further, example embodiments can be used with any of a number of other types of signals, including but not limited to radio frequency (RF) signals, WiFi, Bluetooth, Bluetooth Low Energy (BLE), Zigbee, Z-wave, visible light communication (VLC), RFID, near-field communication (NFC), ultraviolet waves, microwaves, and infrared signals. Communication methods such as Bluetooth, BLE, and WiFi can be referred to herein as communication modes or communication platforms. Example embodiments can be used to receive and broadcast sound in a volume of space in real time.

For electrical devices that are light fixtures, the light fixtures described herein can use one or more of a number of different types of light sources, including but not limited to light-emitting diode (LED) light sources, fluorescent light sources, organic LED light sources, incandescent light sources, and halogen light sources. Therefore, light fixtures described herein, even in hazardous locations, should not be considered limited to a particular type of light source. A light fixture described herein can be any of a number of different types of light fixtures, including but not limited to a pendant light fixture, a troffer light fixture, a floodlight, a spot light, a highbay light fixture, step lights, and a recessed light fixture. Further, the light sources of a light fixture can emit light in one or more of any of a number of ways, including but not limited to backlighting, edge lighting, direct lighting, uplighting, and diffused lighting.

A user may be any person that interacts with a light fixture and/or other object in a volume of space. Specifically, a user may program, operate, and/or interface with one or more components (e.g., a controller, a network manager) associated with a system using example embodiments. Examples of a user may include, but are not limited to, an engineer, an electrician, an instrumentation and controls technician, a mechanic, an operator, a consultant, a contractor, an asset, a network manager, and a manufacturer's representative.

As defined herein, the term enabling is used to embody the different ways that a sound-controlled system can be controlled. Enabling can include any of a number of functions, including but not limited to turning on, turning off, changing volume, playing music, answering a question, controlling an electrical device (e.g., lighting), ordering food, setting a calendar reminder, setting an alarm, adjusting a thermostat, sending a text message, and dialing a phone number.

In certain example embodiments, electrical devices with audio components used to enable smart devices are subject to meeting certain standards and/or requirements. For example, the National Electric Code (NEC), the National Electrical Manufacturers Association (NEMA), the International Electrotechnical Commission (IEC), Underwriters Laboratories (UL), the Federal Communication Commission (FCC), the Bluetooth Special Interest Group, and the Institute of Electrical and Electronics Engineers (IEEE) set standards that can be applied to electrical enclosures (e.g., light fixtures), wiring, location services, and electrical connections. Use of example embodiments described herein meet (and/or allow a corresponding device to meet) such standards when required. In some (e.g., PV solar) applications, additional standards particular to that application may be met by the electrical devices described herein.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of using audio components in electrical devices to enable smart devices will be described more fully hereinafter with reference to the accompanying drawings, in which example embodiments of using audio components in electrical devices to enable smart devices are shown. Using audio components in electrical devices to enable smart devices may, however, be embodied in many different forms and should not be construed as limited to the example embodiments set forth herein. Rather, these example embodiments are provided so that this disclosure will be thorough and complete, and will fully convey the scope of using audio components in electrical devices to enable smart devices to those of ordinary skill in the art. Like, but not necessarily the same, elements (also sometimes called components) in the various figures are denoted by like reference numerals for consistency.

Terms such as “first”, “second”, “outer”, “inner”, “top”, “bottom”, “on”, and “within” are used merely to distinguish one component (or part of a component or state of a component) from another. Such terms are not meant to denote a preference or a particular orientation, and are not meant to limit embodiments of using audio components in electrical devices to enable smart devices. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

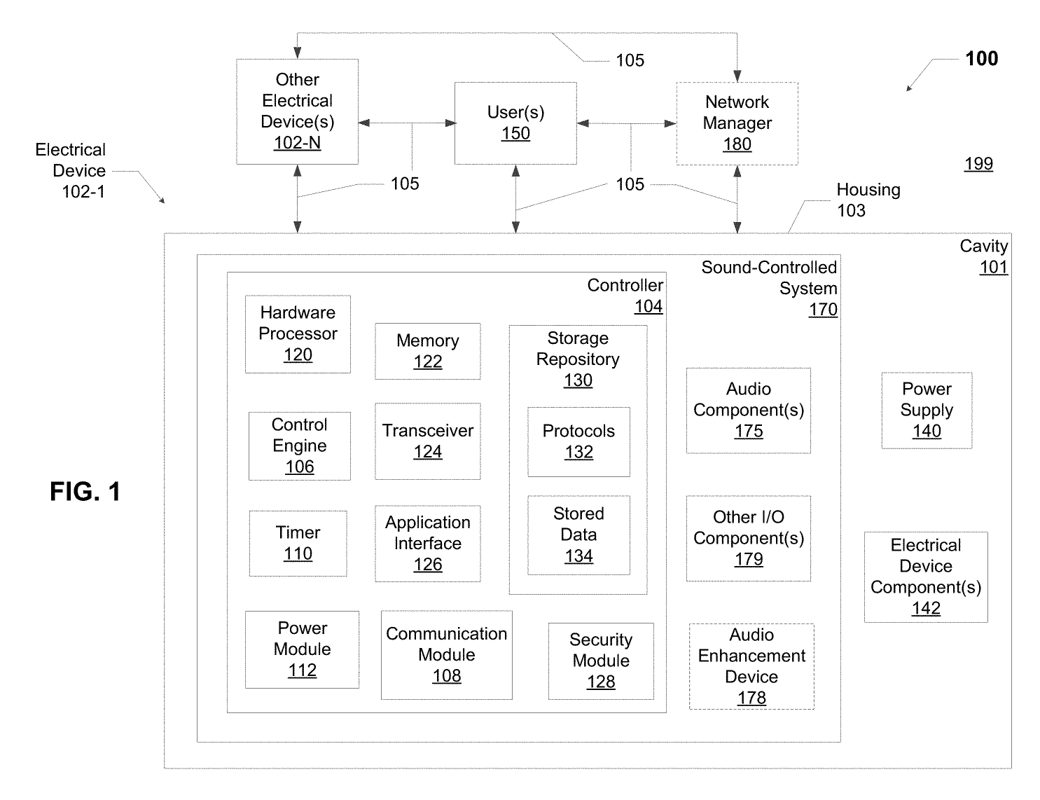

FIG. 1 shows a diagram of a system 100 that includes one or more electrical devices 102 (e.g., electrical device 102-1, other electrical devices 102-N) in accordance with certain example embodiments. The system 100 can also include one or more users 150 and an optional network manager 180, some or all of which can be located in a volume of space 199. The electrical device 102-1 can include a sound-controlled system 170 (which includes a controller 104, one or more audio components 175, an optional audio enhancement device 178, and one or more optional other input/output (I/O) components 179), a power supply 140, and a number of electrical device components 142. The controller 104 of the sound-controlled system 170 can include one or more of a number of components. Such components, can include, but are not limited to, a control engine 106, a communication module 108, a timer 110, a power module 112, a storage repository 130, a hardware processor 120, a memory 122, a transceiver 124, an application interface 126, and, optionally, a security module 128.

An electrical device 102 can be any type of device that uses electricity to operate. Examples of an electrical device 102 are listed above, including a sound-controlled system 170. One or more of the components of the electrical device 102-1 can also be included in one or more of the other electrical devices 102-N in the system 100. Alternatively, a component (e.g., the controller 104) shown in FIG. 1 can be a stand-alone component. The components shown in FIG. 1 are not exhaustive, and in some embodiments, one or more of the components shown in FIG. 1 may not be included in the example system 100.

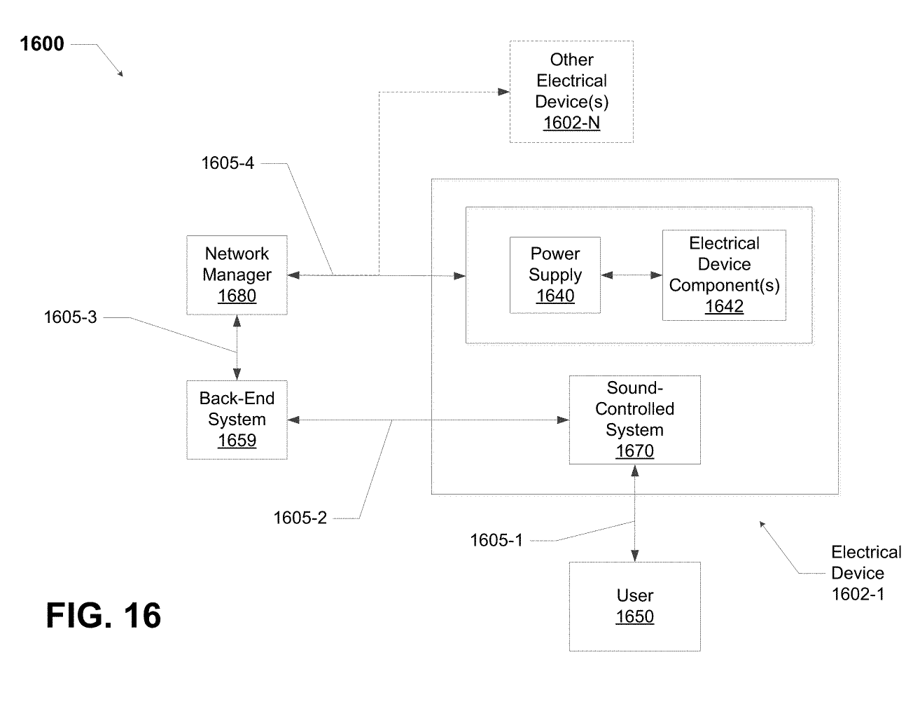

For instance, any component of the example electrical device 102-1 can be discrete or combined with one or more other components of the electrical device 102-1. As an example, the controller 104 can be part of an audio component 175. As another example, the power supply can be located in a junction box that is remote from the housing 103 of the electrical device 102-1. As still another example, the sound-controlled system 170 can be augmented by and/or be combined with a back-end service, such as back-end system 1659 of FIG. 16 below.

The user 150 is the same as a user defined above. The user 150 can use a user system (not shown), which may include a display (e.g., a GUI). The user 150 interacts with (e.g., sends data to, receives data from) the controller 104 of an electrical device 102-1 via the application interface 126 (described below). The user 150 can also interact with the optional network manager 180. Interaction between the user 150, the electrical devices 102, and the network manager 180 is conducted using communication links 105. Alternatively, the user 150 may interact with the electrical devices 102 via audio exchanges.

Each communication link 105 can include wired (e.g., Class 1 electrical cables, Class 2 electrical cables, electrical connectors) and/or wireless (e.g., Wi-Fi, visible light communication, cellular networking, Bluetooth, Zigbee, BLE, WirelessHART, ISA100, Power Line Carrier, RS485, DALI) technology. For example, a communication link 105 can be (or include) one or more electrical conductors that are coupled to the housing 103 of an electrical device 102-1 and to the network manager 180. The communication link 105 can transmit signals (e.g., power signals, communication signals, control signals, data) between the electrical devices 102, the user 150, and the network manager 180.

The optional network manager 180 is a device or component that controls all or a portion of the system 100 that includes the controller 104 of the sound-controlled system 170 and the controllers of the other electrical devices 102-N in the system 100. The network manager 180 can in some cases include functionality to receive sound or a sequence of sounds from the controller 104, interpret the content of the sounds, and communicate with the electrical device 102-1 (or other electrical devices 102-N in the system 100) based on the contents of the sounds. The network manager 180 can in some such cases generate and assign a unique sound to each electrical device 102 so that the particular electrical device 102 can be identified by the sound it emits.

The network manager 180 can be or include components that are substantially similar to the controller 104. Alternatively, the network manager 180 can include one or more of a number of features in addition to, or altered from, the features of the controller 104 described below. If the electrical device 102-1 is a stand-alone device, the network manager 180 and/or the other electrical devices 102-N can be withdrawn from the system 100.

The sound-controlled system 170 of FIG. 1 is a variation of smart speakers that currently exist in the art. Examples of such devices currently known in the art include the Amazon Dot, the Amazon Echo, Google Home, the Sonos Beam, and the Apple HomePod. These existing smart speakers are stand-alone devices that sit, for example, on a table top or counter. In example embodiments, the sound-controlled system 170 can operate substantially similar to existing smart speakers, but the configuration of example sound-controlled systems 170 described herein are different.

For example, in certain example embodiments, at least one component (e.g., the microphones) that is integrated in currently-existing smart speakers is integrated with some portion (e.g., a housing, a trim) of an electrical device 102. In other words, the sound-controlled systems 170 (or portions thereof) described herein can be deconstructed, at least to some extent, and the deconstructed portions can be integrated with an electrical device 102.

Example embodiments of a sound-controlled system 170 described herein can be an existing smart speaker that is incorporated, in its entirety, into an electrical device 102 (e.g., a light fixture). Alternatively, example embodiments of a sound-controlled system 170 described herein can be an existing smart speaker that is substantially incorporated, but where at least one component (e.g., a microphone or other form of audio component 175) of that existing smart speaker is integrated into a portion of the electrical device 102 into which the substantial portion of the smart speaker is also integrated. As yet another alternative, example embodiments of a sound-controlled system 170 described herein can completely deconstruct the components (e.g., controller 104, audio components 175 (e.g., speaker, microphone)) of the existing smart speaker and incorporate those components individually into one or more portions of an electrical device 102.

The user 150, the network manager 180, and/or any other applicable electrical devices 102-N can interact with the controller 104 of the sound-controlled system 170 using the application interface 126 in accordance with one or more example embodiments. Specifically, the application interface 126 of the controller 104 receives data (e.g., information, communications, instructions) from and sends data (e.g., information, communications, instructions) to the user 150, the controller 104 of another electrical device 102-N or another sound-controlled system, and/or the network manager 180. The user 150 and the network manager 180 can include an interface to receive data from and send data to the controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

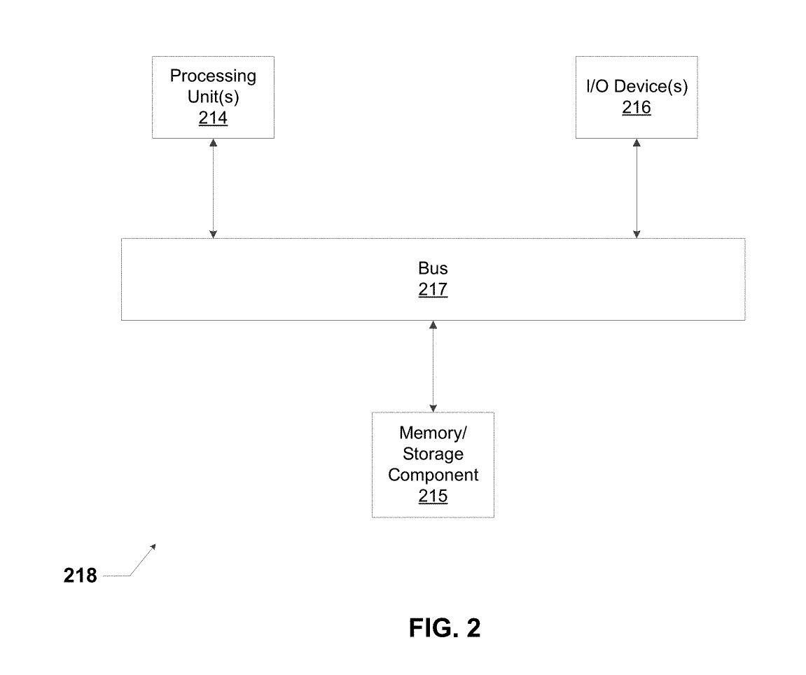

The controller 104, the user 150, and the network manager 180 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with Local Area Network (LAN), Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 2.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The electrical device 102-1 can include a housing 103. The housing 103 can include at least one wall that forms a cavity 101. In some cases, the housing 103 can be designed to comply with any applicable standards so that the electrical device 102-1 can be located in a particular environment (e.g., a hazardous environment). For example, if the electrical device 102-1 is located in an explosive environment, the housing 103 can be explosion-proof.

The housing 103 of the electrical device 102-1 can be used to house one or more components of the electrical device 102-1, including one or more components of the sound-controlled system 170, including some or all of the controller 104. For example, as shown in FIG. 1, the sound-controlled system 170 (which includes the controller 104 (which in this case includes the control engine 106, the communication module 108, the timer 110, the power module 112, the storage repository 130, the hardware processor 120, the memory 122, the transceiver 124, the application interface 126, and the optional security module 128), the one or more audio components 175, the optional audio enhancement device 178, and the one or more optional other I/O components 179), the power supply 140, and the electrical device components 142 are disposed in the cavity 101 formed by the housing 103. In alternative embodiments, any one or more of these or other components of the electrical device 102-1 can be disposed on the housing 103 and/or remotely from the housing 103. For example, a microphone (a type of audio component 175) can be remotely located from the housing 103 but communicably coupled to the controller 104 of the sound-controlled system 170. In any of these cases, a component (e.g., an audio component 175, the sound-controlled system 170) of the electrical device 102-1, or portions thereof, can be said to be integrated with respect to the housing 103 of the electrical device 102-1.

The storage repository 130 can be a persistent storage device (or set of devices) that stores software and data used to assist the controller 104 in communicating with the user 150, the network manager 180, and any other applicable electrical devices 102-N within the system 100. In one or more example embodiments, the storage repository 130 stores one or more protocols 132 and stored data 134. The protocols 132 can be any procedures (e.g., a series of method steps) and/or other similar operational procedures that the control engine 106 of the controller 104 follows based on certain conditions at a point in time.

The protocols 132 can also include any of a number of communication protocols that are used to send and/or receive data between the controller 104 and the user 150, the network manager 180, and any other applicable electrical devices 102-N. One or more of the communication protocols 132 can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the communication protocols 132 can provide a layer of security to the data transferred within the system 100.

Stored data 134 can be any historical, present, and/or forecast data. Stored data 134 can be associated with any of the electrical devices 102, the network manager 180, a user 150, and an audio component 175. Such data can include, but is not limited to, a manufacturer of an audio component 175, a model number of an audio component 175, a location of another electrical device 102, audio captured by an audio component 175, settings, default values, user preferences, communication capability of an audio component 175, and age of an audio component 175.

The storage repository 130 can also include other types of data, including but not limited to formulas, algorithms, and models. For example, the storage repository 130, through a combination of protocols 132 and/or algorithms, can allow the control engine 106 of the controller 104 to receive and interpret sound captured by an audio component 175 in the form of a microphone. As another example, the storage repository 130, through a combination of protocols 132 and/or algorithms, can allow the control engine 106 of the controller 104 to send instructions (or, more generally, signals) to an audio component 175 in the form of a speaker, through which sound can be broadcast.

As yet another example, the storage repository 130, through a combination of protocols 132 and/or algorithms, can allow the control engine 106 of the controller 104 to send sound (or a digital representation of sound) to another controller of another electrical device 102 and/or to a network manager 180. As still another example, the storage repository 130, through a combination of protocols 132 and/or algorithms, can allow the control engine 106 of the controller 104 to send sound (or a digital representation of sound) to one of the audio components 175 (e.g., a speaker).

Examples of a storage repository 130 can include, but are not limited to, a database (or a number of databases), a file system, a hard drive, flash memory, some other form of solid state data storage, or any suitable combination thereof. The storage repository 130 can be located on multiple physical machines, each storing all or a portion of the protocols 132 and/or the stored data 134 according to some example embodiments. Each storage unit or device can be physically located in the same or in a different geographic location.

The storage repository 130 can be operatively connected to the control engine 106. In one or more example embodiments, the control engine 106 includes functionality to communicate with the user 150, the network manager 180, and any other applicable electrical devices 102-N in the system 100. More specifically, the control engine 106 sends information to and/or receives information from the storage repository 130 in order to communicate with the user 150, the network manager 180, and any other applicable electrical devices 102-N. As discussed below, the storage repository 130 can also be operatively connected to the communication module 108 in certain example embodiments.

In certain example embodiments, the control engine 106 of the controller 104 controls the operation of one or more other components (e.g., the communication module 108, the timer 110, the transceiver 124) of the controller 104. For example, the control engine 106 can put the communication module 108 in “sleep” mode when there are no communications between the controller 104 and another component (e.g., the user 150) in the system 100 or when communications between the controller 104 and another component in the system 100 follow a regular pattern. In such a case, power consumed by the controller 104 is conserved by only enabling the communication module 108 when the communication module 108 is needed.

As another example, the control engine 106 can direct the timer 110 when to provide a current time, to begin tracking a time period, and/or perform another function within the capability of the timer 110. As yet another example, the control engine 106 can operate (e.g., turn on, turn off, increase/decrease amplification) one or more of the audio components 175. This example provides another instance where the control engine 106 can conserve power used by the controller 104 and other components (e.g., a speaker, a microphone) of the electrical device 102-1.

The control engine 106 of the controller 104 can, in some cases, receive audio captured by one or more audio components 175 from a user 150 or another audio component 175 (e.g., a speaker) of another electrical device 102. In some cases, each electrical device 102 can have some form of a controller 104, audio component 175, and/or other sensor device 176. The control engine 106 of one controller 104 of the sound-controlled system 170 can coordinate with the controllers 104, audio components 175, and/or sound-controlled systems 170 of one or more of the other electrical devices 102-N.

In some cases, the control engine 106 has a learning and feedback function. For example, a user 150 can broadcast an instruction that a certain electrical device 102 be turned on. If the control engine 106 determines that the particular electrical device 102 is already on, the control engine 106 can inform the user 150 of this fact. In addition, in some such cases, the control engine 106 can offer alternatives to the user 150. For example, using the above example, the control engine 106 can suggest that an adjacent electrical device 102 can be turned on to complement the electrical device 102 that is already on.

For example, the control engine 106 of the controller 104, using a combination of protocols 132 and/or algorithms, can receive and interpret sound captured by an audio component 175, for example in the form of one or more microphones. As another example, the control engine 106 of the controller 104, using a combination of protocols 132 and/or algorithms, can send instructions (or, more generally, signals) to an audio component 175, for example in the form of one or more speakers, through which sound can be broadcast.

In certain example embodiments, the control engine 106 of the controller 104, through a combination of protocols 132 and/or algorithms, can take some action or actions that is responsive to the sound or series of sounds received through an audio component 175. For example, if the sound received by the sound-controlled system 170 is a statement from a user 150 saying “Dim the light by 50%.”, and the electrical device 102-1 with which the sound-controlled system 170 is integrated is a light fixture, the control engine 106 can determine the content of the sound and then control the power supply 140 and/or one or more of the electrical device components 142 (e.g., a light source) so that the light emitted by the light fixture is dimmed by 50%.

As yet another example, the control engine 106 of the controller 104, through a combination of protocols 132 and/or algorithms, can send sound (or a digital representation of sound) received by the sound-controlled system 170 to another controller of another electrical device 102, to a back-end system (e.g., the back-end system 1659 of FIG. 16 below), and/or to a network manager 180. As still another example, the control engine 106 of the controller 104, through a combination of protocols 132 and/or algorithms, can control, in addition to or in the alternative of controlling a function of one or more electrical device components 142 of the electrical device 102-1, one or more of the other electrical devices 102-N, regardless of whether those other electrical devices 102-N are part of the same system or subsystem as the electrical device 102-1 or a different system or subsystem.

The control engine 106 can provide control, communication, and/or other signals to the user 150, the network manager 180, and the other electrical devices 102-N. Similarly, the control engine 106 can receive control, communication, and/or other signals from the user 150, the network manager 180, and/or the other electrical devices 102-N. The control engine 106 can communicate automatically (for example, based on one or more algorithms stored in the storage repository 130) and/or based on control, communication, and/or other similar signals received from another device (e.g., the network manager 180). The control engine 106 may include a printed circuit board, upon which the hardware processor 120 and/or one or more discrete components of the controller 104 can be positioned.

In certain example embodiments, the control engine 106 can include an interface that enables the control engine 106 to communicate with one or more components (e.g., power supply 140) of the electrical device 102-1. For example, if the power supply 140 of the electrical device 102-1 (in this example, a light fixture) operates under IEC Standard 62386, then the power supply 140 can include a digital addressable lighting interface (DALI). In such a case, the control engine 106 can also include a DALI to enable communication with the power supply 140 within the electrical device 102-1. Such an interface can operate in conjunction with, or independently of, the communication protocols 132 used to communicate between the controller 104 and the user 150, the network manager 180, and any other applicable electrical devices 102-N.

The control engine 106 (or other components of the controller 104) can also include one or more hardware and/or software architecture components to perform its functions. Such components can include, but are not limited to, a universal asynchronous receiver/transmitter (UART), a serial peripheral interface (SPI), a digital-to-analog converter (DAC), an analog-to-digital converter (ADC), an inter-integrated circuit (I²C), and a pulse width modulator (PWM).

Using example embodiments, while at least a portion (e.g., the control engine 106, the timer 110) of the controller 104 is always on, the remainder of the controller 104 can be in sleep mode when they are not being used. In addition, the controller 104 can control certain aspects (e.g., sending audio files to and receiving audio files from another electrical device 102 and/or the network manager 180) of one or more other applicable components in the system 100.

The communication network (using the communication links 105) of the system 100 can have any type of network architecture. For example, the communication network of the system 100 can be a mesh network. As another example, the communication network of the system 100 can be a star network. When the controller 104 includes an energy storage device (e.g., a battery as part of the power module 112), even more power can be conserved in the operation of the system 100. In addition, using time-synchronized communication protocols 132, the data transferred between the controller 104 and the user 150, the network manager 180, an object, and/or any other applicable electrical devices 102-N can be secure.

The communication module 108 of the controller 104 determines and implements the communication protocol (e.g., from the protocols 132 of the storage repository 130) that is used when the control engine 106 communicates with (e.g., sends signals to, receives signals from) the user 150, the network manager 180, and/or any other applicable electrical devices 102-N. In some cases, the communication module 108 accesses the stored data 134 to determine which communication protocol is within the capability of a target component of the system 100. In addition, the communication module 108 can interpret the communication protocol of a communication received by the controller 104 so that the control engine 106 can interpret the communication.

The communication module 108 can send data (e.g., protocols 132, stored data 134) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can measure multiple times simultaneously. The timer 110 can track time periods based on an instruction received from the control engine 106, based on an instruction received from the user 150, based on an instruction programmed in the software for the controller 104, based on some other condition or from some other component, or from any combination thereof.

The power module 112 of the controller 104 provides power to one or more other components (e.g., timer 110, control engine 106) of the controller 104. In addition, in certain example embodiments, the power module 112 can provide power to one or more of the audio components 175, the optional audio enhancement device 178, and/or one or more of the other I/O components 179 of the sound-controlled system 170. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned.

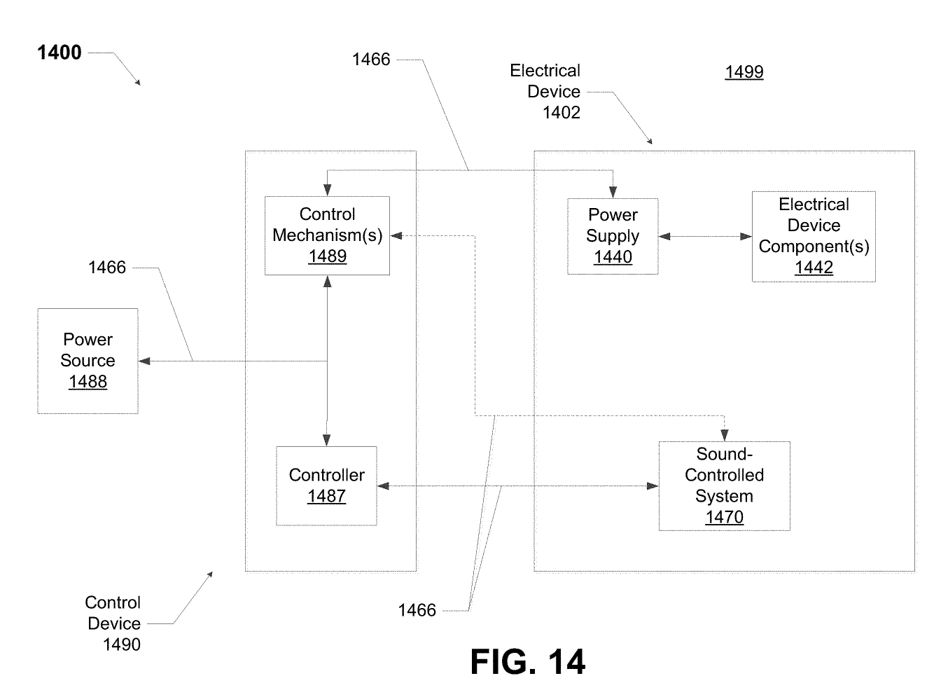

The power module 112 can include one or more components (e.g., a transformer, a diode bridge, an inverter, a converter) that receives power (for example, through an electrical cable) from the power supply 140 and/or from a source (e.g., power source 1488 in FIG. 14 below) external to the electrical device 102-1, and then generates power of a type (e.g., alternating current, direct current) and level (e.g., 12V, 24V, 120V) that can be used by the other components of the controller 104 and/or by the power supply 140. In addition, or in the alternative, the power module 112 can be a source of power in itself to provide signals to the other components of the controller 104 and/or the power supply 140. For example, the power module 112 can be a battery. As another example, the power module 112 can be a localized photovoltaic power system and/or power capacitor.

The hardware processor 120 of the controller 104 executes software in accordance with one or more example embodiments. Specifically, the hardware processor 120 can execute software on the control engine 106 or any other portion of the controller 104, as well as software used by the user 150, and the network manager 180, and/or any other applicable electrical devices 102-N. The hardware processor 120 can be an integrated circuit, a central processing unit, a multi-core processing chip, a multi-chip module including multiple multi-core processing chips, or other hardware processor in one or more example embodiments. The hardware processor 120 is known by other names, including but not limited to a computer processor, a microprocessor, and a multi-core processor. The hardware processor 120 may include an internal or external digital signal processing DSP unit.

In one or more example embodiments, the hardware processor 120 executes software instructions stored in memory 122. The memory 122 includes one or more cache memories, main memory, and/or any other suitable type of memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more field-effect transistors (FETs), and/or one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send and/or receive data, control, and/or communication signals. Specifically, the transceiver 124 can be used to transfer data between the controller 104 and the user 150, the network manager 180, and/or any other applicable electrical devices 102-N. The transceiver 124 can use wired and/or wireless technology. The transceiver 124 can be configured in such a way that the data, control, and/or communication signals sent and/or received by the transceiver 124 can be received and/or sent by another transceiver that is part of the user 150, the network manager 180, and/or any other applicable electrical devices 102-N.

When the transceiver 124 uses wireless technology, any type of wireless technology can be used by the transceiver 124 in sending and receiving signals. Such wireless technology can include, but is not limited to, Wi-Fi, visible light communication, cellular networking, Bluetooth, Zigbee, and BLE. The transceiver 124 can use one or more of any number of suitable communication protocols (e.g., ISA100, HART) when sending and/or receiving signals. Such communication protocols can be stored in the protocols 132 of the storage repository 130. Further, any transceiver information for the user 150, the network manager 180, and/or any other applicable electrical devices 102-N can be part of the stored data 134 (or similar areas) of the storage repository 130.

Optionally, in one or more example embodiments, the security module 128 secures interactions between the controller 104, the user 150, the network manager 180, and/or any other applicable electrical devices 102-N. More specifically, the security module 128 authenticates communication from software based on security keys verifying the identity of the source of the communication. For example, user software may be associated with a security key enabling the software of the user 150 to interact with the controller 104 of the sound-controlled system 170. Further, the security module 128 can restrict receipt of information, requests for information, and/or access to information in some example embodiments.

As mentioned above, aside from the sound-controlled system 170 and its components, the electrical device 102-1 can include a power supply 140, one or more audio components 175, a sound-controlled system 170, and one or more electrical device components 142. The electrical device components 142 of the electrical device 102-1 are devices and/or components typically found in an electrical device to allow the electrical device 102-1 to operate. An electrical device component 142 can be electrical, electronic, mechanical, or any combination thereof. The electrical device 102-1 can have one or more of any number and/or type of electrical device components 142.

If the electrical device 102 is a light fixture, examples of such electrical device components 142 can include, but are not limited to, a controller, a power supply (e.g., a driver, a ballast), a light source, a light engine, a heat sink, an electrical conductor or electrical cable, a terminal block, a lens, a diffuser, a reflector, an air moving device, a baffle, a dimmer, a trim, and a circuit board. If the “legacy” portions of the electrical device 102 (the components of the electrical device 102 not related to or shared with the sound-controlled system 170) includes a controller, then the controller can include one or more of a number of components described herein with respect to the controller 104 of the sound-controlled system 170. In some cases, the controller 104 of the sound-controlled system 170 can also control the one or more electrical device components 142 of the electrical device 102-1. In other cases, if the electrical device 102-1 includes its own controller, then such controller can share some, but not all, of the components of the controller 104 of the sound-controlled system 170.

The power supply 140 of the electrical device 102-1 can provide power to the sound-controlled system 170 (e.g., the controller 104, the audio components 175, the optional audio enhancement device 178, the other I/O components 179) and/or one or more of the electrical device components 142. If the electrical device 102-1 is a light fixture, the power supply 140 can be referred to as a driver, a LED driver, a ballast, or any other suitable name known to those of ordinary skill in the art. The power supply 140 can be substantially the same as, or different than, the power module 112 of the controller 104. The power supply 140 can include one or more of a number of single or multiple discrete components (e.g., transistor, diode, resistor), and/or a microprocessor. The power supply 140 may include a printed circuit board, upon which the microprocessor and/or one or more discrete components are positioned.

The power supply 140 can include one or more components (e.g., a transformer, a diode bridge, an inverter, a converter) that receives power (for example, through an electrical cable) from or sends power to the power module 112 of the controller 104. The power supply can generate, based on power that it receives, power of a type (e.g., alternating current, direct current) and level (e.g., 12V, 24V, 120V) that can be used by the recipients (e.g., the electrical device components 142, the controller 106) of such power. In addition, or in the alternative, the power supply 140 can receive power from a source external to the electrical device 102-1 or from the power module 112 of the controller 104. In addition, or in the alternative, the power supply 140 can be a source of power in itself. For example, the power supply 140 can be a battery, a localized photovoltaic power system, or some other source of independent power.

As discussed above, the sound-controlled system 170 includes one or more audio components 175. An audio component 175 is a device that captures or broadcasts sounds. Examples of sounds can include, but are not limited to, a human voice, a digitized voice, music, and a noise emitting from a device (e.g., a whistle), A sound can have any of a number of frequencies, which can fall within or outside a range of human audibility. An audio component 175 can record or broadcast sound in digital or analog format.

An audio component 175 can include one or more of any number of components, including but not limited to storage, a hardware processor, memory, a power module, and a controller. For example, an audio component 175 in the form of a microphone can include one or more components that digitally record a sound captured by the microphone. Some of these components of an audio component 175 can be duplicative of, or shared with, the controller 104 or other associated components of the electrical device 102. An audio component 175 can be in a fixed position and capture a constant portion of a volume of space 199.

Alternatively, an audio component 175 can have some capabilities or settings (e.g., pan, tilt, focus) that allow for some control over the audio component 175 to capture sound and/or broadcast sound within the volume of space 199. For example, if the audio component 175 is a speaker, the settings of the speaker can be adjusted so that sound emitted from the speaker is only directed to a targeted portion of the volume of space 199. As stated above, an audio component 175 can be communicably coupled to the controller 104 of the sound-controlled system 170. In such a case, the controller 104 can control the settings (e.g., pan, tilt, focus, digital quality) of the audio component 175 and when the audio component 175 captures a sound or broadcasts a sound within the volume of space 199.

Also, as discussed above, the sound-controlled system 170 includes an optional audio enhancement device 178. At times, the quality of one or more of the audio components 175 (e.g., speakers, microphones) is not of sufficient quality to detect and/or broadcast sounds sufficiently clear. In such cases, the audio enhancement device 178 can be used to clarify sounds that are received and/or broadcast. The audio enhancement device 178 can include one or more of a number of components (e.g., resistor, capacitor, IC, diode, transistor) that are configured to clarify and/or amplify sounds so that those sounds are more clear and decipherable.

Further, as discussed above, the sound-controlled system 170 includes one or more other optional I/O components 179. An I/O component 179 is a device that captures or broadcasts light, communication signals, movement, and/or some other suitable element. An I/O component 179 can include one or more of any number of components, including but not limited to storage, a hardware processor, memory, a power module, and a controller. For example, an I/O component 179 in the form of a light source can include a local controller that controls the on/off, intensity, lumen output, color, strobing, and/or other output characteristics of one or more light engines of the light source. In such a case, the I/O component 179 can be used for any of a number of purposes, such as indicating a status of the sound-controlled system 170. Some of these components of an I/O component 179 can be duplicative of, or shared with, the controller 104 or other associated components of the electrical device 102. An I/O component 179 can be in a fixed position and interact with a constant portion of the volume of space 199.

Alternatively, an I/O component 179 can have some capabilities or settings (e.g., pan, tilt, focus) that allow for some control over the I/O component 179 to interact within the volume of space 199. For example, if the audio component 175 is a light source, the settings of the light source can be adjusted so that light emitted from the light source is only directed to a targeted portion of the volume of space 199. Similarly, an optional I/O component 179 (e.g., a light source) can be communicably coupled to the controller 104 of the sound-controlled system 170. In such a case, the controller 104 can control the settings (e.g., on, off, dimming) of the I/O component 179 and how the I/O component 179 interacts with the volume of space 199.

In certain example embodiments, an audio component 175 and/or an I/O component 179 can be disposed at, within, or on any portion of the electrical device 102-1. For example, an audio component 175 can be disposed on the housing 103 of the electrical device 102-1. As another example, an I/O component 179 can be disposed within the cavity 101 of the housing 103, where a portion of the I/O component 179 peeks through an aperture that traverses the housing 103 of the electrical device 102-1. In some cases, an audio component 175 and/or I/O component 179 can be shared with functionality of the electrical device 102-1, regardless of whether the audio component 175 and/or the I/O component 179 is not physically attached to the electrical device 102-1.

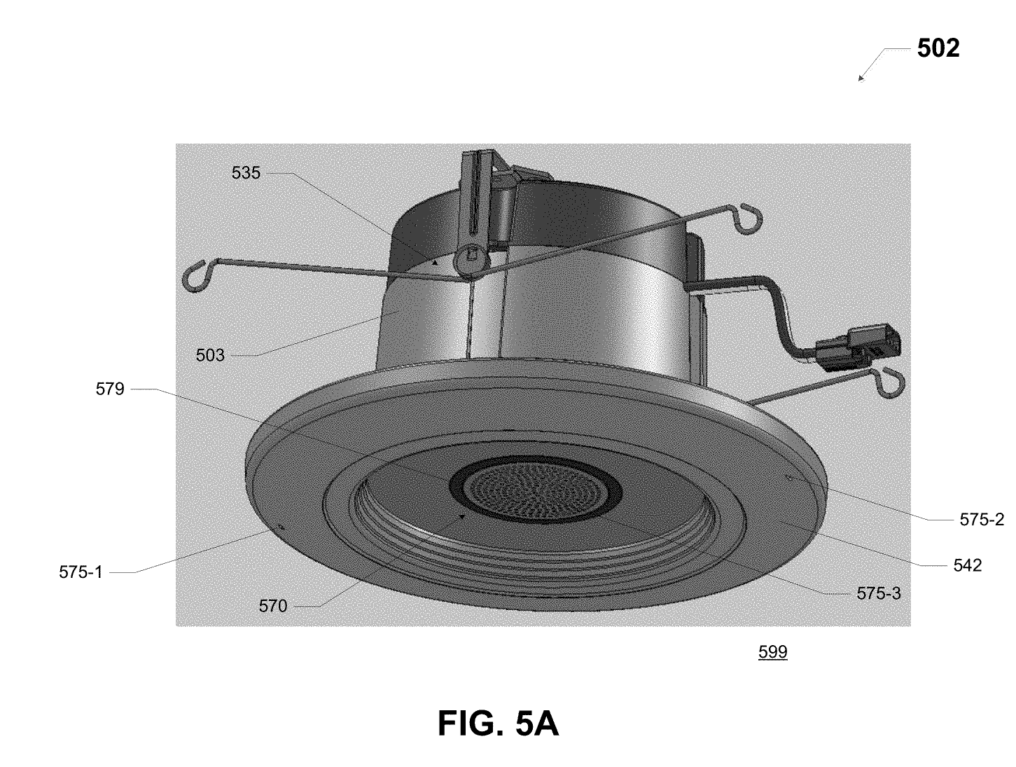

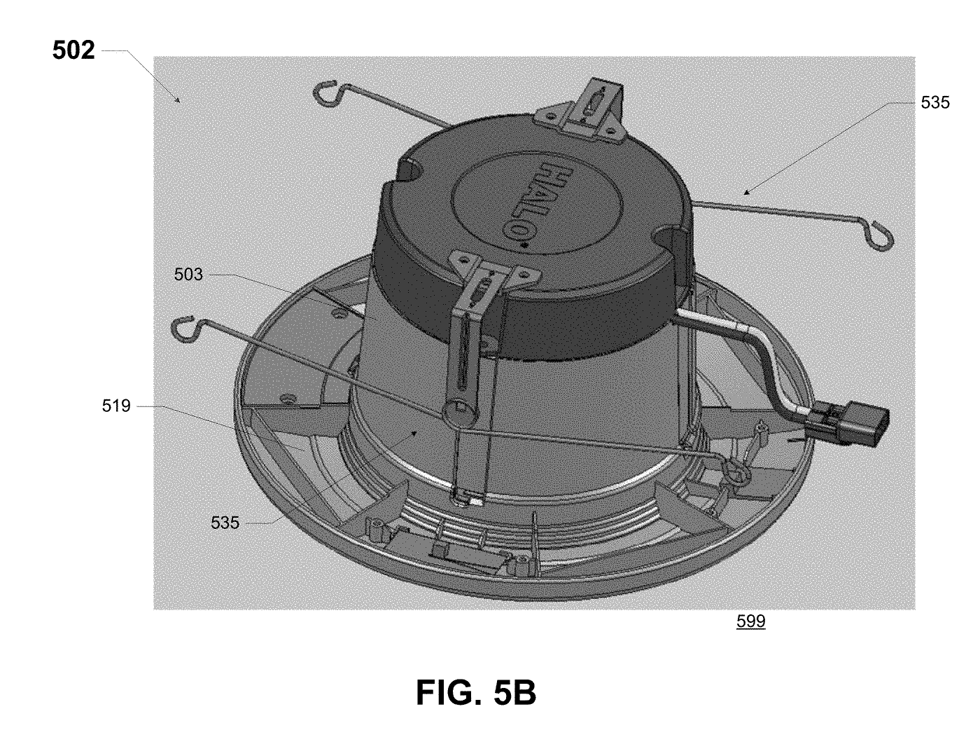

In certain example embodiments, the audio components 175 and the optional I/O components 179 can be controlled by the control engine 106. For example, the control engine 106 can determine which audio components 175 and I/O components 179 receive power (e.g., from the power supply 140) at a particular point in time. As another example, if an I/O component 179 is a LED ring (as shown in FIG. 5 below), then the control engine 106 can have the operation of the LED ring tied to the operation of the power supply 140.

In certain example embodiments, the sound-controlled system 170 is an electrical device that is controlled, at least in part, using sound (which can mean a single sound or a series or grouping of sounds). The sound used to control the sound-controlled system 170 can be from one or more of a number of sources and/or types. Examples of such sounds that can control the sound-controlled system 170 can include, but are not limited to, a human voice, a digitized voice, music, and a noise emitting from a device (e.g., a whistle). The sound can be live or recorded. Examples of a sound-controlled system 170 can include, but are not limited to, the Echo by Amazon, Google Assistant, Cortana by Microsoft, and Siri by Apple.

The sound-controlled system 170, using the controller 104, can receive a sound, interpret the sound as an instruction, and respond to the instruction in the appropriate manner. For example, if the sound is a question verbalized by a user 150, the sound-controlled system 170 receives the sound, recognizes the question and the contents of that question, finds an answer to the question, and communicates (e.g., in a digitized voice using a speaker) a response to the question. As another example, if the sound is an instruction verbalized by a user 150, the sound-controlled system 170 receives the sound, recognizes the instruction and the contents of that instruction, and performs an action (e.g., turns on a light) in response to the instruction.

In example embodiments described herein, the audio components 175 of an electrical device 102 are used provide the sound, directly or indirectly, to the sound-controlled system 170. In addition, or in the alternative, the audio components 175 (e.g., a speaker) of the sound-controlled system 170 can be used broadcast a response to the volume of space 199.

The sound-controlled system 170 (or portion thereof) can be disposed at, within, or on any portion of the electrical device 102-1 or any other electrical device 102. For example, the sound-controlled system 170 (or portion thereof) can be disposed on the housing 103 of the electrical device 102-1. As another example, the sound-controlled system 170 (or portion thereof) can be disposed within the cavity 101 of the housing 103, where a portion of the sound-controlled system 170 peeks through an aperture that traverses the housing 103 of the electrical device 102-1. In some cases, the sound-controlled system 170 is a stand-alone device in the system 100. The sound-controlled system 170 can more generally be referred to as a smart device herein.

FIG. 2 illustrates one embodiment of a computing device 218 that implements one or more of the various techniques described herein, and which is representative, in whole or in part, of the elements described herein pursuant to certain exemplary embodiments. For example, computing device 218 can be implemented in the electrical device 102-1 of FIG. 1 in the form of the hardware processor 120, the memory 122, and the storage repository 130, among other components. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, SD card, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a laser light pointer, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a local area network (LAN), a wide area network (WAN) such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

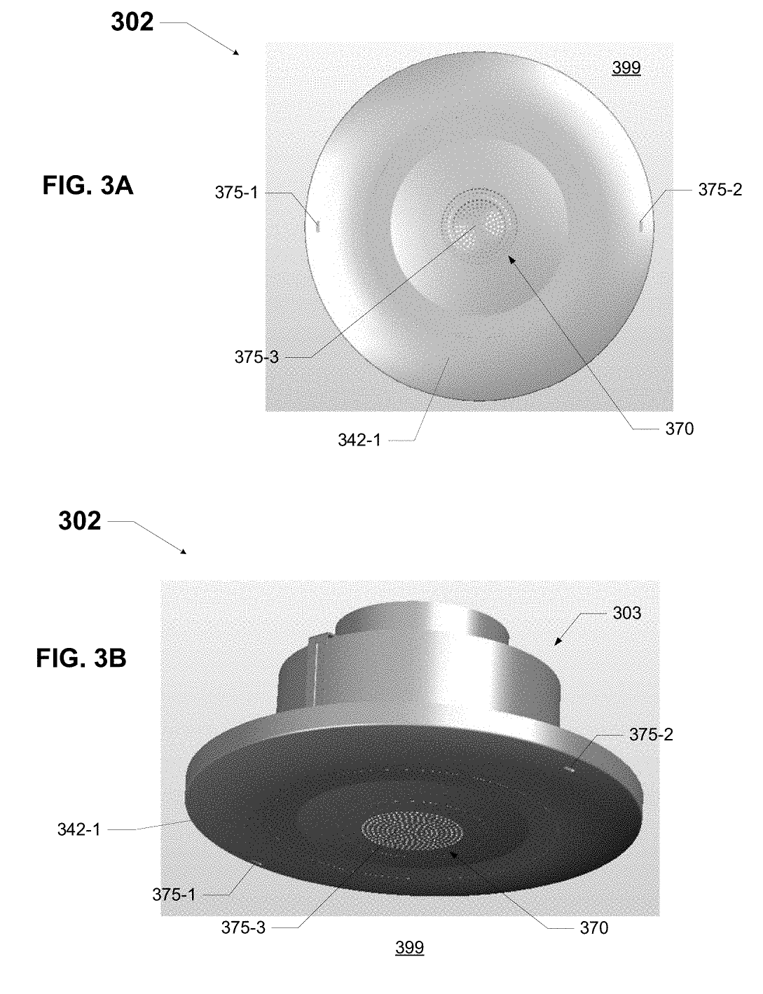

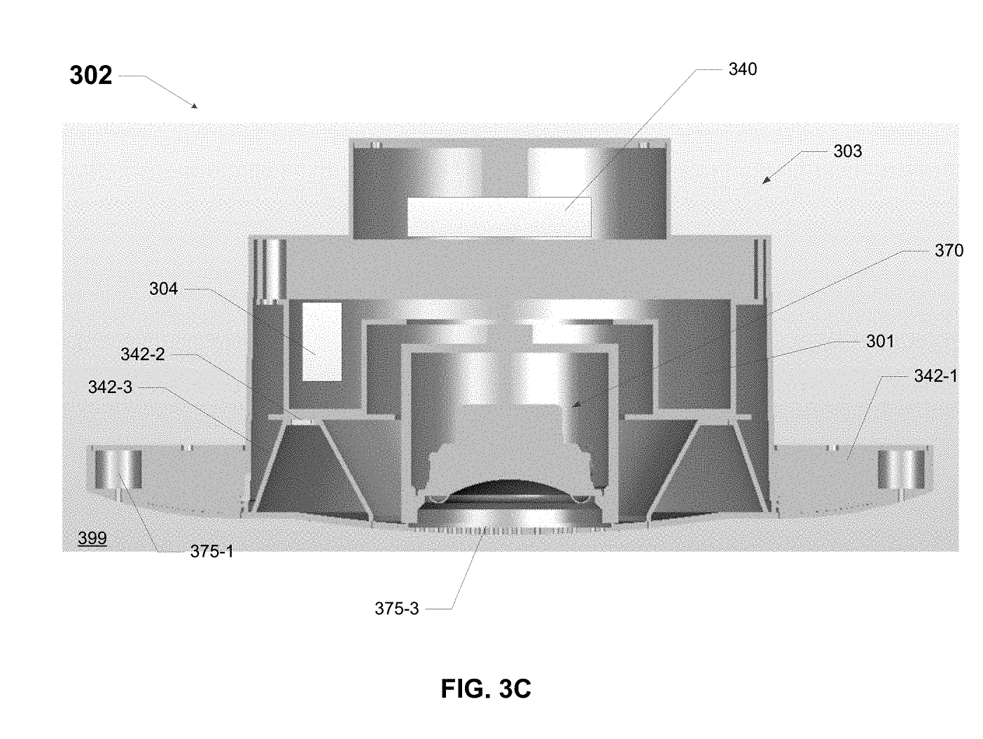

FIGS. 3A-3C show various views of an electrical device 302 in accordance with certain example embodiments. Specifically, FIG. 3A shows a bottom view of the electrical device 302. FIG. 3B shows a bottom-front-side perspective view of the electrical device 302. FIG. 3C shows a cross-sectional side view of the electrical device 302. In this case, the electrical device 302 is a light fixture.

Referring to FIGS. 1 through 3C, the electrical device 302 of FIGS. 3A-3C includes a housing 303 that forms a cavity 301, inside of which is disposed a power supply 340, a sound-controlled system 370, at least one electrical device component 342 (in this case, a trim 342-1, a number of light sources 342-2 and at least one reflector 342-3), at least one audio component 375 (in this case, microphone 375-1 and microphone 375-2), and a controller 304.

One or more of the components of the electrical device 302 can also be disposed on the housing 303. For example, in this case, one audio component 375 (in this case, speaker 375-3) is integrated with the bottom surface of the electrical device 302, and parts of two audio components 375 (in this case, microphone 375-1 and microphone 375-2) are exposed to the ambient environment 399 through apertures in the trim 342-1 that are adjacent to microphone 375-1 and microphone 375-2. The microphones 375-1 and 375-2, the speaker 375-3, and the sound-controlled system 370 are communicably coupled to each other, and are also exposed to an ambient environment in the volume of space 399 in which the electrical device 302 is disposed. In certain example embodiments, the controller 304 is also coupled to the microphones 375-1 and 375-2, the speaker 375-3, and the sound-controlled system 370.

The microphones 375-1 and 375-2 and the speaker 375-3 are normally part of the sound-controlled system 370 currently known in the art, as a stand-alone device. According to example embodiments, the sound-controlled system 370 is integrated with the electrical device 302. As one example, as shown in FIGS. 3A-3C, some of the features (in this case, microphone 375-1 and microphone 375-2) are physically separated from the rest of the sound-controlled system 370, and yet the sound-controlled system 370 (including the integrated speaker 375-3), microphone 375-1, and microphone 375-2 are all integrated with the electrical device 302. As another example, all of the various features (e.g., microphone 375-1, microphone 375-2, speaker 375-3) associated with the sound-controlled system 370 can all be integrated with a body of the sound-controlled system 370, and the sound-controlled system 370 is integrated with the electrical device 302.

In any case, the microphones 375-1 and 375-2 and the speaker 375-3 are integrated with the electrical device 302 in such a way that the electrical device 302 has substantially the same outward appearance compared to such an electrical device 302 currently known in the art. The sound-controlled system 370 can include one or more of a number of other features. For example, as shown in FIGS. 5A and 5B below, the sound-controlled system 570 can also include a light source 579 (a form of I/O device, such as I/O device 179 of FIG. 1) that forms the outer perimeter of the portion of the sound-controlled system and is visible to a user (e.g., user 150) from below. Such a light source can serve any of a number of purposes, including but not limited to indicating that the sound-controlled system is receiving power, that the sound-controlled system is receiving sound through a microphone (e.g., microphone 375-1, microphone 375-2), and that the sound-controlled system is emitting sound through a speaker (e.g., speaker 375-3).

Integrating audio components 375 into the electrical device 302 can be done in one or more of any number of ways. For example, in terms of orientation, the speaker 375-3 and the microphones 375-1 and 375-2 in this example are disposed on or proximate to the bottom surface of the electrical device 302. As a result, the speaker 375-3 and the microphones 375-1 and 375-2 are disposed in substantially the same horizontal plane. For example, the microphones 375-1 and 375-2 can be disposed within 2 centimeters of a horizontal plane passing through the speaker 375-3. In another example, the microphones 375-1 and 375-2 can be in the same horizontal plane as the speaker 375-3. The electrical device 302 of FIGS. 3A-3C can be a stand-alone device or part of a network.

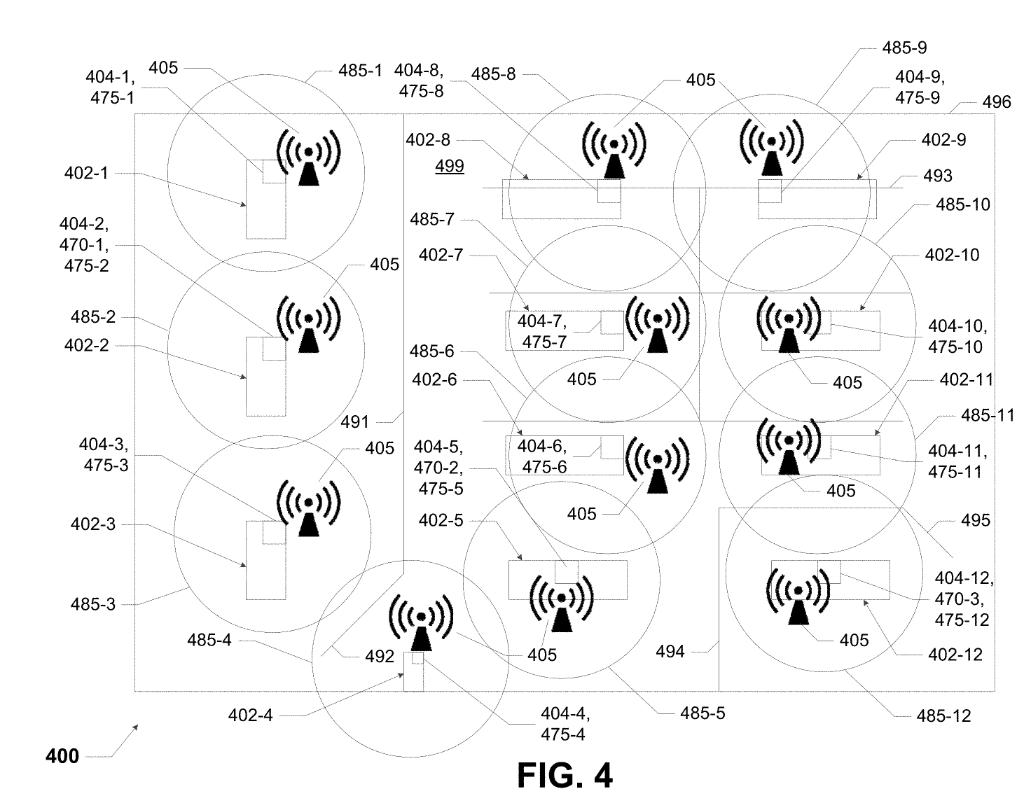

FIG. 4 shows a system 400 located in a volume of space 499 in accordance with certain example embodiments. Specifically, FIG. 4 shows a system 400 that includes a number of interconnected electrical devices 402. Referring to FIGS. 1 through 4, the system 400 of FIG. 4 includes twelve electrical devices 402, where each electrical device 402 of FIG. 4 is a type of light fixture, such as the light fixture (electrical device 302) of FIGS. 3A-3C. Specifically, the system 400 includes light fixture 402-1, light fixture 402-2, light fixture 402-3, light fixture 402-4, light fixture 402-5, light fixture 402-6, light fixture 402-7, light fixture 402-8, light fixture 402-9, light fixture 402-10, light fixture 402-11, and light fixture 402-12. In this case, light fixture 402-4 is an exit light, and the other 11 light fixtures of FIG. 4 are troffer lights.

Each electrical device 402 in the system 400 of FIG. 4 includes one or more audio components 475. Specifically, in this example, light fixture 402-1 includes a controller 404-1 and an audio component 475-1 that is a microphone (but no speaker), but the light fixture 402-1 does not include a sound-controlled system. Light fixture 402-2 includes a controller 404-2, audio components 475-2 that include a microphone and a speaker, and a sound-controlled system 470-1. Light fixture 402-3 includes a controller 404-3 and an audio component 475-3 that is a microphone (but no speaker), but the light fixture 402-3 does not include a sound-controlled system.

Light fixture 402-4 includes a controller 404-4 and an audio component 475-4 that is a microphone (but no speaker), but the light fixture 402-4 does not include a sound-controlled system. Light fixture 402-5 includes a controller 404-5, audio components 475-5 that include a microphone and a speaker, and a sound-controlled system 470-2. Light fixture 402-6 includes a controller 404-6 and an audio component 475-6 that is a microphone (but no speaker), but the light fixture 402-6 does not include a sound-controlled system.

Light fixture 402-7 includes a controller 404-7 and an audio component 475-7 that is a microphone (but no speaker), but the light fixture 402-7 does not include a sound-controlled system. Light fixture 402-8 includes a controller 404-8 and an audio component 475-8 that is a microphone (but no speaker), but the light fixture 402-8 does not include a sound-controlled system. Light fixture 402-9 includes a controller 404-9 and an audio component 475-9 that is a microphone (but no speaker), but the light fixture 402-9 does not include a sound-controlled system.

Light fixture 402-10 includes a controller 404-10 and an audio component 475-10 that is a microphone (but no speaker), but the light fixture 402-10 does not include a sound-controlled system. Light fixture 402-11 includes a controller 404-11 and an audio component 475-11 that is a microphone (but no speaker), but the light fixture 402-11 does not include a sound-controlled system. Light fixture 402-12 includes a controller 404-12, audio components 475-12 that include a microphone and a speaker, and a sound-controlled system 470-3.

In other words, there are three different sound-controlled systems 470, one in each room within the volume of space 499, that is integrated with an electrical device 402. Each electrical device 402 includes its own controller 404, and each electrical device 402 includes an audio component 475-1 that includes at least a microphone. Each controller 404 includes a transceiver that uses a wireless communication link 405 having a range 485 (e.g., 10 meters) that defines a maximum volume within the volume of space 499 in which the transceiver can send and receive signals.

Specifically, the transceiver of controller 404-1 has range 485-1, the transceiver of controller 404-2 has range 485-2, the transceiver of controller 404-3 has range 485-3, the transceiver of controller 404-4 has range 485-4, the transceiver of controller 404-5 has range 485-5, the transceiver of controller 404-6 has range 485-6, the transceiver of controller 404-7 has range 485-7, the transceiver of controller 404-8 has range 485-8, the transceiver of controller 404-9 has range 485-9, the transceiver of controller 404-10 has range 485-10, the transceiver of controller 404-11 has range 485-11, and the transceiver of controller 404-12 has range 485-12.

A transceiver of a controller 404 of an electrical device 402 can communicate with a transceiver of a controller 404 of another electrical device 402 if the range 485 of one transceiver intersects with the range 485 of another transceiver. In this example, range 485-1 intersects range 485-2, which intersects range 485-3, which intersects range 485-4, which intersects range 485-5, which intersects range 485-6, which intersects range 485-7, which intersects range 485-8, which intersects range 485-9, which intersects range 485-10, which intersects range 485-11, which intersects range 485-12. In other words, the controllers 404 of the electrical devices 402 of FIG. 4 are communicably coupled to each other in a daisy-chain configuration. In other embodiments, the range 485 of the transceiver of the controller 404 of one electrical device 402 can intersect with more than two ranges 485 of the transceivers of the controllers 404 of one or more other electrical devices 402.

The electrical devices 402 of the system 400 of FIG. 4 are located within a volume of space 499. A volume of space 499 can be any interior and/or exterior space in which one or more electrical devices of the system 400 can be located. In this case, the volume of space 499 is part of an office space that is defined by exterior walls 496 that form the outer perimeter of the volume of space 499. The volume of space 499 in this case is divided into a number of areas.

For example, a wall 491 and a door 492 separate a hallway (in which light fixture 402-1, light fixture 402-2, and light fixture 402-3 are located) from a work space (in which the remainder of the light fixtures 402 are located). A small office, defined by wall 494 and door 495, and in which light fixture 402-12 is located, subdivides the work space within the volume of space 499. Light fixture 402-4, the exit sign, is located above the door 492 within the work space. A number of cubicle walls 493 are located within the work space. The communication links 405, as in this case using radio frequency waves, can be capable of having a range 485 that extend beyond a wall, door, or other boundary within the volume of space 499.

Since all of the electrical devices 402 in the system 400 of FIG. 4 are in communication with each other, and since each electrical device 402 in the system 400 includes an audio component 475 that is a microphone, any one or more of the sound-controlled systems 470 can be controlled by a user (e.g., user 150) located anywhere in the volume of space 499, even if the user is not within direct audible range of the microphone of the electrical device 402 with which a sound-controlled system 470 is integrated.

For example, suppose that a user is located in the upper right corner of the volume of space 499 in FIG. 4, adjacent to light fixture 402-9, and speaks a voice command to the sound-controlled system 470 in a normal, conversational tone of voice, In such a case, the microphones of light fixture 402-5, light fixture 402-12, and light fixture 402-2 would not receive the voice command spoken by the user, and so in the current art, stand-alone sound-controlled systems located in the volume of space 499 proximate to where light fixture 402-5, light fixture 402-12, and light fixture 402-2 are located would not respond to the voice command of the user.

However, using example embodiments, the microphone of light fixture 402-9, would capture the voice command spoken by the user in the upper right corner of the volume of space 499. Once the microphone of light fixture 402-9 captures the voice command, the controller 404-9 of light fixture 402-9 can process and interpret the voice command, and the controller 404-9 of light fixture 402-9 can subsequently send the voice command to one or more of the other light fixtures in the system 400,

For example, the controller 404-9 of light fixture 402-9 can send the voice command to the controller 404-8 of light fixture 402-8. In such a case, the controller 404-8 of light fixture 402-8 can then send the voice command to the controller 404-7 of light fixture 402-7, which can then send the voice command to the controller 404-6 of light fixture 402-6, which can then send the voice command to the controller 404-5 of light fixture 402-5, When the controller 404-5 of light fixture 402-5 receives the forwarded voice command, the controller 404-5 can send the voice command to the sound-controlled system 470-2 integrated with the light fixture 402-5. At that time, the sound-controlled system 470-2 can respond to the voice command.

If the range 485 of a transceiver of controller 404 is larger than what is shown in FIG. 4, then fewer intermediate light fixtures would need to be involved in the process of relaying the voice command. When there are multiple sound-controlled systems 470 in a system 400, as in this case, a sound (e.g., a voice commend, a voice request) can be directed to one, multiple, or all of the sound-controlled systems 470 in the system 400.

As stated above, the sound-controlled systems described herein that are integrated into an electrical device (e.g., a light fixture) can be done in any of a number of ways, and the electrical device can be any of a number of electrical devices. For example, as discussed above, the speaker and/or microphone of a sound-controlled system integrated into an electrical device can be placed anywhere on or even remotely from the electrical device. Even further, for a given type of electrical device, example embodiments can be integrated with any variation thereof. FIGS. 5A through 13 below show various examples of light fixtures (when the electrical device is a light fixture) into which example sound-controlled systems can be integrated.

FIGS. 5A and 5B show an electrical device 502 in accordance with certain example embodiments. Referring to FIGS. 1 through 5B, the electrical device 502 in this case is a light fixture that is substantially similar to the electrical device 302 of FIGS. 3A-3C, except as described below. For example, the electrical device 502 of FIGS. 5A and 5B has integrated therein a sound-controlled system 570, which has a speaker 575-3 integrated therein. The electrical device 502 includes a housing 503, at least one electrical device component 542 (e.g., a number of light sources, at least one reflector), at least one audio component 575 (in this case, microphone 575-1 and microphone 575-2) integrated into the trim 542, and a controller (e.g., controller 104), which is disposed within the housing 503 and is hidden from view.

The microphones 575-1 and 575-2, the speaker 575-3, and the sound-controlled system 570 are communicably coupled to each other, and are also exposed to an ambient environment in the volume of space 599 in which the electrical device 502 is disposed. In certain example embodiments, the controller is also coupled to the microphones 575-1 and 575-2, the speaker 575-3, and the sound-controlled system 570.

In addition, the electrical device 502 of FIGS. 5A and 5B has several other features that are not included in the electrical device 302 of FIGS. 3A-3C. For example, the sound-controlled system 570 of FIGS. 5A and 5B also includes a light source 579 (a form of other I/O component, such as I/O component 179 of FIG. 1) that forms the outer perimeter of the portion of the sound-controlled system 570 and is visible to a user (e.g., user 150) from below. Such a light source 579 can serve any of a number of purposes, including but not limited to indicating that the sound-controlled system 570 is receiving power, that the sound-controlled system 570 is receiving sound through microphone 575-1 and/or microphone 575-2, and that the sound-controlled system 570 is emitting sound through speaker 575-3. Generally speaking, one of the purposes of the light source 579 can be to indicate the status of the sound-controlled system 570.

In addition, the electrical device 502 of FIGS. 5A and 5B includes a pair of mounting features 535 that are disposed on an outer surface of the housing 503. In this case, each mounting feature 535 is a torsion spring (also called a spring clip) that is used to help secure the electrical device 502 to some mounting surface (e.g., a can, a recessed housing, drywall, wood, a beam) external to the electrical device 502. Also shown in the example of FIGS. 5A and 5B is a pair of wires extending from the housing 503 with an electrical connector at the end of the pair of wires. The pair of wires and connector facilitate making power and/or data connections to the electrical device 502.

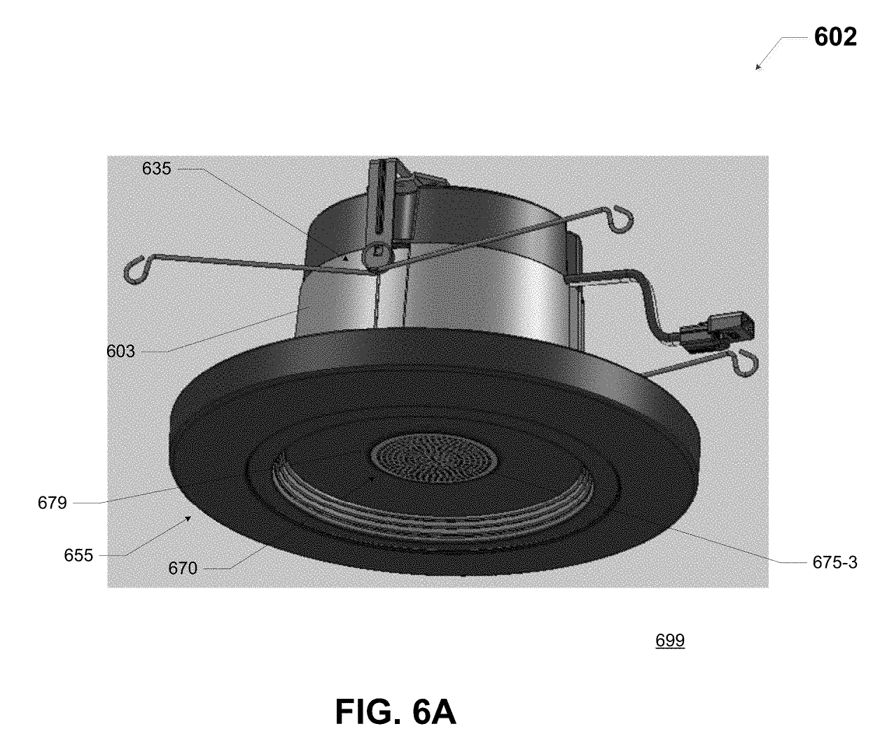

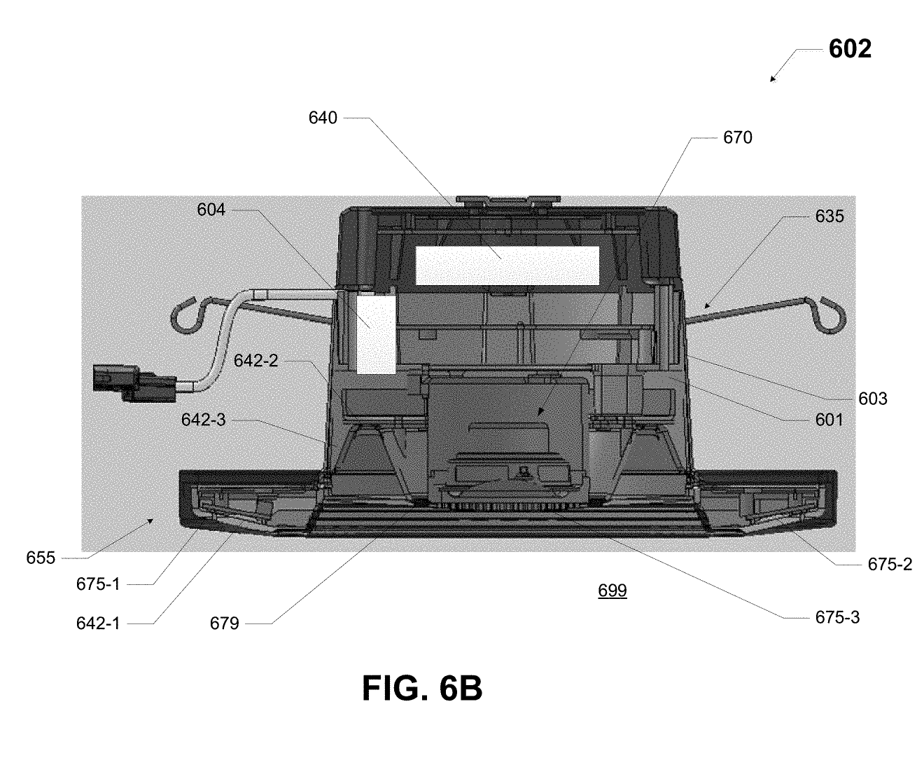

FIGS. 6A and 6B show yet another electrical device 602 in accordance with certain example embodiments. Referring to FIGS. 1 through 6B, the electrical device 602 in this case is a light fixture that is substantially similar to the electrical device 502 of FIGS. 5A and 5B, except as described below. For example, the electrical device 602 of FIGS. 6A and 6B has integrated therein a sound-controlled system 670, which has a speaker 675-3 integrated therein. The electrical device 602 includes a housing 603, at least one electrical device component 642 (e.g., a number of light sources 642-2, at least one reflector 642-3), at least one audio component 675 (in this case, microphone 675-1 and microphone 675-2) integrated into the trim 642-1, and a controller (e.g., controller 104), which is disposed within the housing 603 and is hidden from view

The microphones 675-1 and 675-2, the speaker 675-3, and the sound-controlled system 670 are communicably coupled to each other, and are also exposed to an ambient environment in the volume of space 699 in which the electrical device 602 is disposed. In certain example embodiments, the controller is also coupled to the microphones 675-1 and 675-2, the speaker 675-3, and the sound-controlled system 670. The electrical device 602 of FIGS. 6A and 6B also includes mounting features 635 having the same configuration and location on the housing 603 as the mounting features 535 of FIGS. 5A and 5B. Further, the sound-controlled system 670 of FIGS. 6A and 6B also includes a light source 679 (substantially similar to the light source 579 of FIGS. 5A and 5B) that forms the outer perimeter of the portion of the sound-controlled system 670.

In addition, the electrical device 602 of FIGS. 6A and 6B has at least one other feature that is not included in the electrical device 502 of FIGS. 5A and 5B. Specifically, the electrical device 602 of FIGS. 6A and 6B includes a cover 655 that is coupled to and disposed over the trim 642-1. The cover 655 can also be used to cover one or more other portions of the electrical device 602 that are exposed to the ambient environment in the volume of space 699 when the electrical device 602 is installed. For example, in this case, the cover 655 covers the outer portions of the electrical device 602 between the trim 642-1 and the light source 679 of the sound-controlled system 670.

The cover 655 can be coupled to one or more of any parts of the electrical device 602. For example, the cover 655 can be coupled to the trim 642-1. Alternatively, as in this example, the cover 655 acts like a sleeve that covers both the upper and lower surfaces of the trim 642-1. The cover 655 can be rigid and/or flexible. The cover 655 can be made from one or more of a number of materials, including but not limited to rubber, plastic, acrylic, glass, and metal. If the cover 655 is coupled to one or more portions of the electrical device 602, the cover 655 can include one or more of a number of coupling features (e.g., tabs, slots, detents, apertures, snaps. Velcro) that allow the cover 655 to be directly or indirectly coupled to the electrical device 602. In some cases, the electrical device 602 can include one or more coupling features that complement (for example, in terms of configuration and location) the coupling features of the cover 655.

The cover 655 can be purely decorative. For example, the cover 655 can have a particular color and/or pattern on its outer surface. The cover 655 can be removable and/or interchangeable by a user (e.g., user 150). In some cases, the cover 655 can serve a practical purpose. For example, the cover 655 can provide a protective barrier to the electrical device 602 when the electrical device 602 is installed in an extreme environment (e.g., high humidity, as above a shower stall). The cover 655 can have one or more apertures to accommodate one or more components (e.g., microphone 675-1, microphone 675-2) of the electrical device 602. Alternatively, the cover 655 can be made of a material or otherwise configured in a way to coexist with components such as microphone 675-1 and microphone 675-2 without affecting the performance of those components.

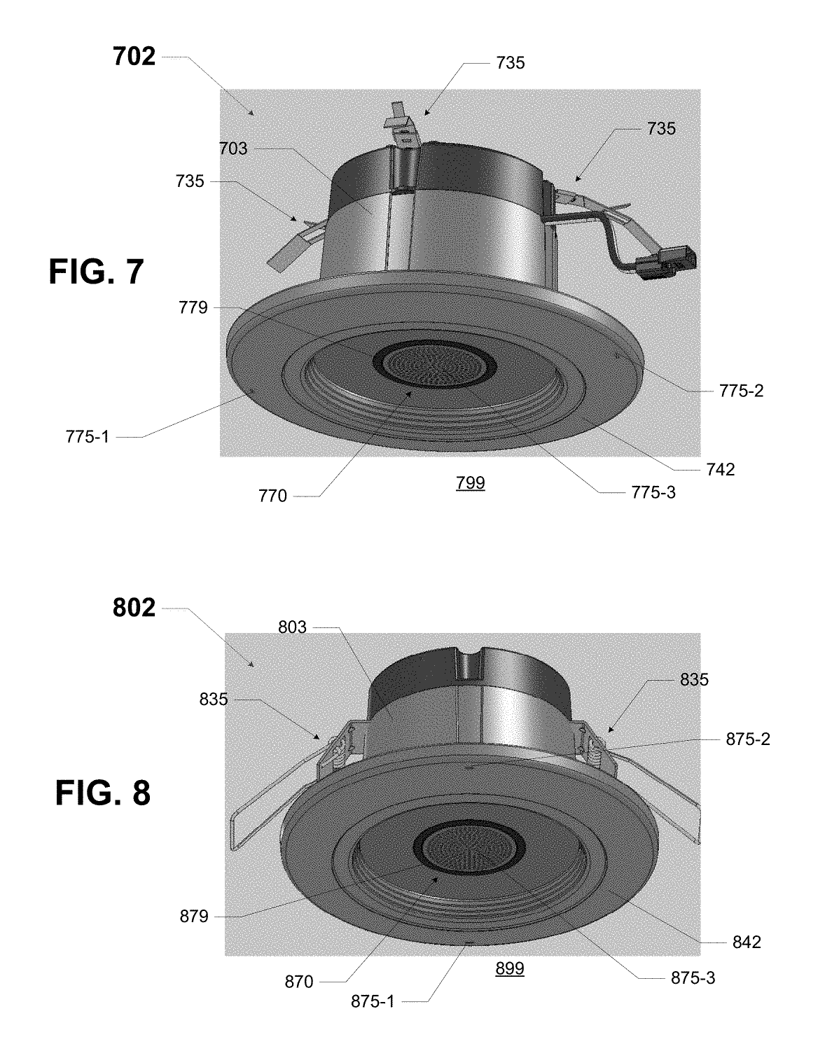

FIG. 7 shows still another electrical device 702 in accordance with certain example embodiments. Referring to FIGS. 1 through 7, the electrical device 702 in this case is a light fixture that is substantially similar to the electrical device 502 of FIGS. 5A and 5B, except as described below. For example, the electrical device 702 of FIG. 7 has integrated therein a sound-controlled system 770, which has a speaker 775-3 integrated therein. The electrical device 702 includes a housing 703, at least one electrical device component 742 (e.g., a number of light sources, at least one reflector), at least one audio component 775 (in this case, microphone 775-1 and microphone 775-2) integrated into the trim 742, and a controller (e.g., controller 104), which is disposed within the housing 703 and is hidden from view.

The microphones 775-1 and 775-2, the speaker 775-3, and the sound-controlled system 770 are communicably coupled to each other, and are also exposed to an ambient environment in the volume of space 799 in which the electrical device 702 is disposed. In certain example embodiments, the controller is also coupled to the microphones 775-1 and 775-2, the speaker 775-3, and the sound-controlled system 770. Further, the sound-controlled system 770 of FIG. 7 also includes a light source 779 (substantially similar to the light source 579 of FIGS. 5A and 5B) that forms the outer perimeter of the portion of the sound-controlled system 770.

In addition, the electrical device 702 of FIG. 7 includes four mounting features 735 (three of which are visible in FIG. 7) that are disposed on an outer surface of the housing 703. In this case, each mounting feature 735 is a friction blade that is used to help secure the electrical device 702 to some mounting surface (e.g., a can, drywall, wood, a beam) external to the electrical device 702.

FIG. 8 shows yet another electrical device 802 in accordance with certain example embodiments. Referring to FIGS. 1 through 8, the electrical device 802 in this case is a light fixture that is substantially similar to the electrical device 502 of FIGS. 5A and 5B, except as described below. For example, the electrical device 802 of FIG. 8 has integrated therein a sound-controlled system 870, which has a speaker 875-3 integrated therein. The electrical device 802 includes a housing 803, at least one electrical device component 842 (e.g., a number of light sources, at least one reflector), at least one audio component 875 (in this case, microphone 875-1 and microphone 875-2) integrated into the trim 842, and a controller (e.g., controller 104), which is disposed within the housing 803 and is hidden from view.

The microphones 875-1 and 875-2, the speaker 875-3, and the sound-controlled system 870 are communicably coupled to each other, and are also exposed to an ambient environment in the volume of space 899 in which the electrical device 802 is disposed. In certain example embodiments, the controller is also coupled to the microphones 875-1 and 875-2, the speaker 875-3, and the sound-controlled system 870. Further, the sound-controlled system 870 of FIG. 8 also includes a light source 879 (substantially similar to the light source 579 of FIGS. 5A and 5B) that forms the outer perimeter of the portion of the sound-controlled system 870.

In addition, the electrical device 802 of FIG. 8 includes two spring-loaded direct mount clips 835 that are disposed on an outer surface of the housing 803. In this case, each mounting feature 835 is used to help secure the electrical device 802 to some mounting surface (e.g., a can, drywall, wood, a beam) external to the electrical device 802.

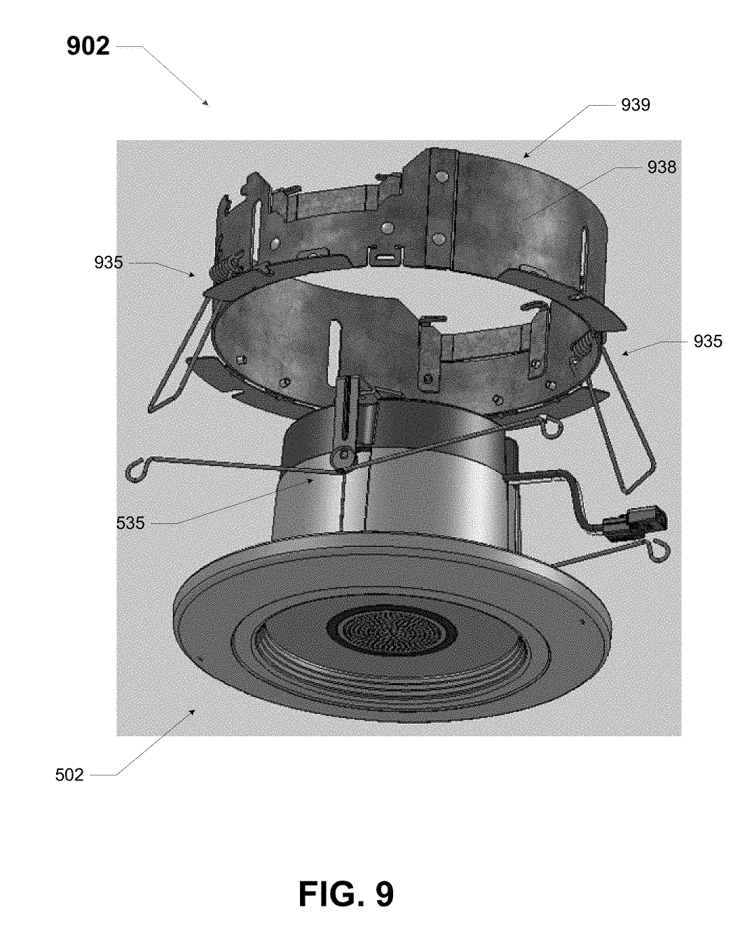

FIG. 9 shows still another electrical device 902 in accordance with certain example embodiments. Referring to FIGS. 1 through 9, the electrical device 902 in this case includes the electrical device 502 of FIGS. 5A and 5B as well as an adapter ring assembly 939. The adapter ring assembly 939 includes an adapter ring 938 and two spring-loaded direct mount clips 935 (substantially similar to the spring-loaded direct mount clips 835 of FIG. 8) that are disposed on an outer surface of the adapter ring 938. In this case, each mounting feature 535 of the electrical device 502 is used to secure the electrical device 502 to the adapter ring 938, and each mounting feature 935 of the adapter ring assembly 939 is used to help secure the electrical device 902 to some mounting surface (e.g., a can, drywall, wood, a beam) external to the adapter ring assembly 939.

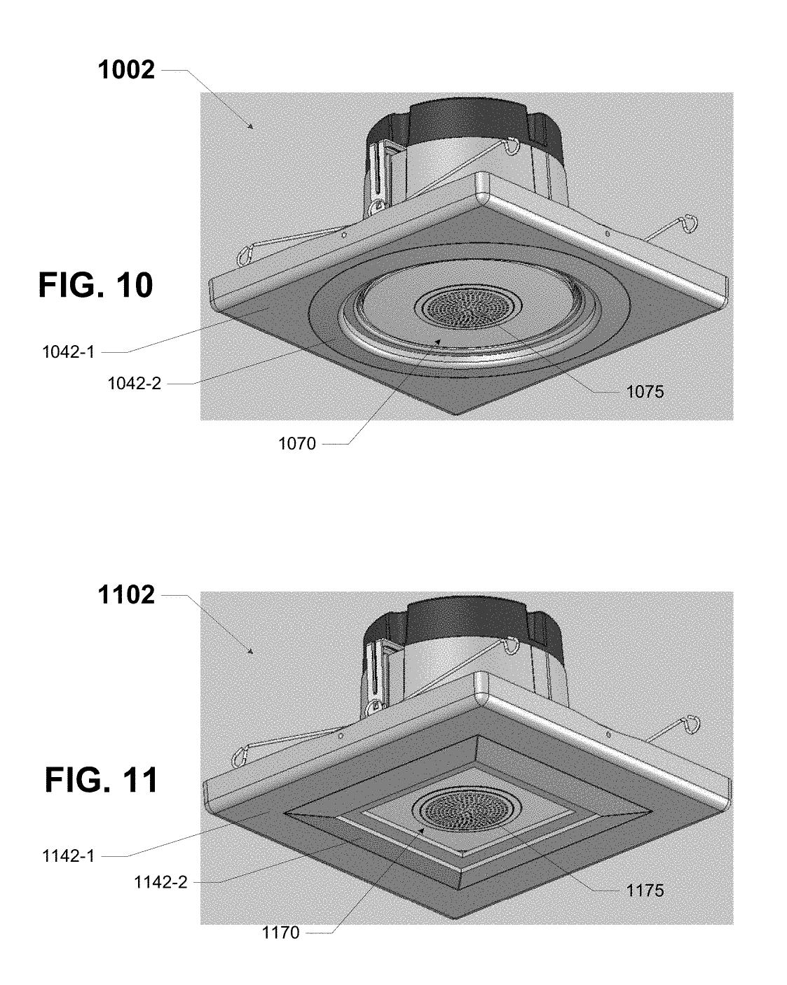

FIG. 10 shows yet another electrical device 1002 in accordance with certain example embodiments. Referring to FIGS. 1 through 10, the electrical device 1002 in this case is a light fixture that is substantially similar to the electrical device 502 of FIGS. 5A and 5B, except as described below. Specifically, the trim 1042 of the electrical device 1002 of FIG. 10 is in multiple (in this case, two) pieces. The outer trim 1042-1 has a square profile in contrast to the circular profile of the trim 542-1 of the electrical device 502 of FIGS. 5A and 5B. The inner trim 1042-2 of the electrical device 1002 of FIG. 10 is circular in shape and complements the shape and size of the inner surface of the outer trim 1042-1. The inner trim 1042-2 has a larger inner perimeter than the outer perimeter of the speaker 1075 of the sound-controlled system 1070, and so avoids overlapping the speaker 1075.

FIG. 11 shows still another electrical device 1102 in accordance with certain example embodiments. Referring to FIGS. 1 through 11, the electrical device 1102 in this case is a light fixture that is substantially similar to the electrical device 502 of FIGS. 5A and 5B, except as described below. Specifically, the trim 1142 of the electrical device 1102 of FIG. 11 is in multiple (in this case, two) pieces. The outer trim 1142-1 has a square profile in contrast to the circular profile of the trim 542-1 of the electrical device 502 of FIGS. 5A and 5B. The inner trim 1142-2 of the electrical device 1102 of FIG. 11 also has a square profile with an outer perimeter that abuts against the inner perimeter of the outer trim 1142-1. The inner trim 1142-2 has a larger inner perimeter than the outer perimeter of the speaker 1175 of the sound-controlled system 1170, and so avoids overlapping the speaker 1175.

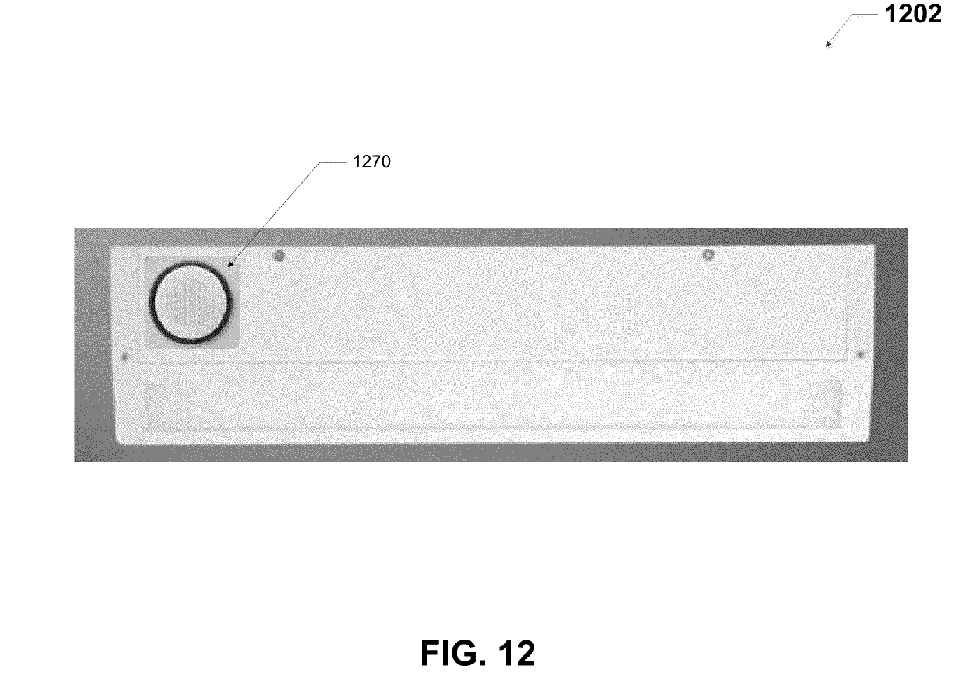

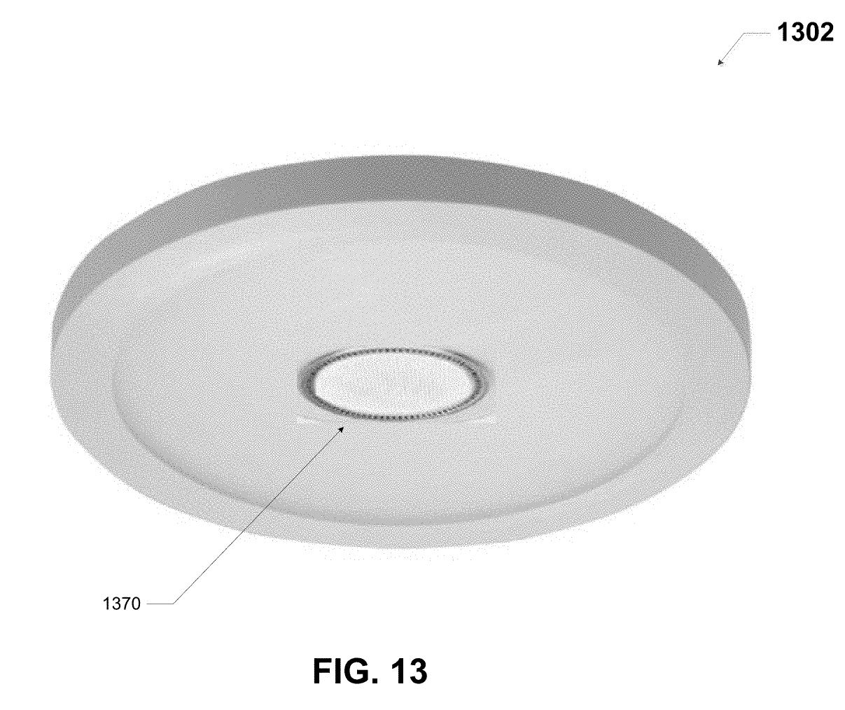

As stated above, example embodiments can be used in any variation of a particular electrical device. For example, if the electrical device is a light fixture, example embodiments can be used in any of a number of types of light fixtures. FIGS. 3A-3C and 5A-11, example sound-controlled systems can be integrated into down can light fixtures. FIGS. 12 and 13 show a few other types of light fixtures with which example sound-controlled systems can be integrated.

FIG. 12 shows yet another electrical device 1202 in accordance with certain example embodiments. Specifically, referring to FIGS. 1 through 12, the electrical device 1202 of FIG. 12 is an under cabinet light fixture into which a sound-controlled system 1270 is integrated. FIG. 13 shows still another electrical device 1302 in accordance with certain example embodiments. Specifically, referring to FIGS. 1 through 13, the electrical device 1302 of FIG. 13 is a surface-mounted wave guide light fixture into which a sound-controlled system 1370 is integrated.

FIG. 14 shows a diagram of another system 1400 that includes an electrical device 1402 in accordance with certain example embodiments. Referring to FIGS. 1 through 14, the electrical device 1402 of the system 1400 of FIG. 14 can be substantially the same as the electrical device 102 of FIG. 1. For example, the electrical device 1402 of FIG. 14 includes a power supply 1440 (substantially similar to the power supply 140 of FIG. 1), one or more electrical device components 1442 (substantially similar to the electrical device components 142 of FIG. 1), and a sound-controlled system 1470 (substantially similar to the sound-controlled system 170 of FIG. 1).

In addition to the electrical device 1402, the system 1400 includes a control device 1490 and a power source 1488. The power source 1488 is coupled to the control device 1490 by one or more electrical conductors 1466, and the control device 1490 is coupled to the electrical device 1402 by multiple electrical conductors 1466. An electrical conductor 1466 can be made of one or more of a number of electrically conductive materials (e.g., copper, aluminum). The size (e.g., gauge) of an electrical conductor 1466 is sufficient to transmit power between two components in the system 1400. Each electrical conductor 1466 may be coated with an insulator made of any of a number of suitable materials (e.g., rubber, plastic) to keep the electrically conductive material electrically isolated an adjacent electrical conductor 1466.

The power source 1488 of the system 1400 can generate, directly or indirectly, power in the form of alternating current (AC) or direct current (DC) power. A primary power source 110 can also generate power at any of a number of appropriate amounts. Examples of voltages generated by the power source 1488 can include 120VAC, 240VAC, 277VAC, 24VDC, 48VDC, 380VDC, and 480VAC. If the power generated by the power source 1488 is AC power, the frequency can be 50 Hz, 60 Hz, or some other frequency. Examples of the power source 1488 (or portion thereof) can include, but are not limited to, a battery, a photovoltaic (PV) solar panel, a wind turbine, a power capacitor, an energy storage device, a power transformer, a fuel cell, a generator, and a circuit panel.

The power generated by the power source 1488 is sent to the control device 1490 using one or more electrical conductors 1466. In some cases, the power source 1488 can include a power transfer device (e.g., a transformer, a converter, an inverter, an inductor, a diode bridge). In such a case, the power transfer device can convert power received by the power source 1488 into a form of power that can be used by the control device 1490.

The control device 1490 of the system 1400 can include one or more of a number of components. For example, in this case, the control device 1490 includes at least one control mechanism 1489 (e.g., a switch) and a controller 1487. A control mechanism 1489 can determine whether power from the power sources 1488 to the power supply 1440 of the electrical device 1402 at any particular point in time. In some cases, as with a 2-pole switch, a control mechanism 1489 has an open state and a closed state. In the open state, the control mechanism 1489 creates an open circuit, which prevents power from the power source 1488 from being delivered to the power supply 1440 of the electrical device 1402. In the closed state, the control mechanism 1489 creates a closed circuit, which allows power from the power source 1488 to be delivered to the power supply 1440 of the electrical device 1402. In other cases, when a control mechanism 1489 is a switch, the control mechanism 1489 can have 3 or more poles, where each pole is coupled to a different power source and/or a different power supply 1440 of the electrical device 1402 or multiple electrical devices 1402.

In certain example embodiments, the position of each control mechanism 1489 can be manually controlled by a user (e.g., user 150). Each control mechanism 1489 can be any type of device that changes state or position (e.g., opens, closes) based on certain conditions. Examples of a control mechanism 1489 can include, but are not limited to, a transistor, a dipole switch, a dial, a slider, a relay contact, a resistor, and a digital gate. In certain example embodiments, each control mechanism 1489 can operate (e.g., change from a closed position to an open position, change from an open position to a closed position) based on input from the controller 1487. A control mechanism 1489 can be a physical control mechanism or a virtual control mechanism (e.g., software-based).

In this case, the one or more control mechanisms 1489 are only coupled (using the electrical conductors 1466) to the power supply 1440 of the electrical device 1402. Put another way, the control mechanisms 1489 are not coupled to the sound-controlled system 1470 of the electrical device 1402. In this way, the control mechanisms 1489 do not interrupt power from being delivered to the sound-controlled system 1470, regardless of whether the electrical device components 1442 (e.g., a light source when the electrical device 1402 is a light fixture) are operating or receiving power based on the position of the control mechanisms 1489.

The control device 1490 can have any of a number of forms and be placed in any of a number of locations and/or environments. For example, the control device 1490 can be disposed within or integrated with a wallbox mounted on a wall. In such a case, the control mechanism 1489 can be a slide bar that serves as a dimmer when the electrical device 1402 is a light fixture and when one or more of the electrical device components 1442 is a light source. In such a case, the control mechanism 1489 can control the amount of power (e.g., no power, full power, half power) delivered to the power source 1440 of the electrical device 1402 without affecting the amount of power (full power) delivered to the sound-controlled system 1470. As another example, the control device 1490 can be an app on a mobile device (a form of user system).

In certain example embodiments, as when the control mechanism 1489 is not manually controlled by a user (e.g., user 150), the controller 1487 of the control device 1490 can control the position of each control mechanism 1489 of the control device 1490. The controller 1487 of the control device 1490 can include one or more components that are substantially similar to the components of the controller 104 of the sound-controlled system 170 of FIG. 1 discussed above. For example, the controller 1487 of the control device 1490 can include a control engine, a transceiver, memory, a hardware processor, a communication module, a storage repository, a power module, a timer, and a security module, all of which can be substantially similar to the corresponding components described above with respect to the controller 104 of FIG. 1.

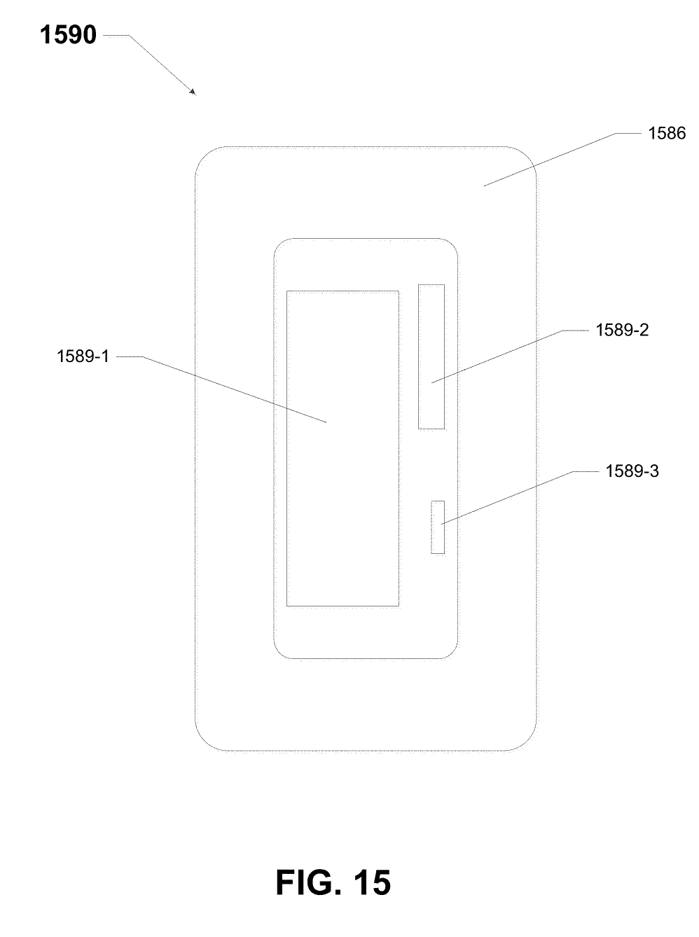

In certain example embodiments, the control device 1490 can include one or more control mechanisms 1489 that are dedicated to the sound-controlled system 1470. In other words, that particular control mechanism 1489 would only be coupled to the sound-controlled system 1470, using one or more electrical conductors 1466, and not to the power supply 1440 of the electrical device 1402. In such a case, the control mechanism 1489 dedicated to the sound-controlled system 1470, when operated in a specific sequence (multiple changes of positions), can instruct the sound-controlled system 1470 to take some action (e.g., reset itself). An example of such a control device 1490 with multiple control mechanisms 1489 is shown below with respect to FIG. 15.

FIG. 15 shows an example of a control device 1590 in accordance with certain example embodiments. Referring to FIGS. 1 through 15, the control device 1590 is substantially the same as the control device 1490 described above with respect to FIG. 14. In this case, the control device 1590 is a wallbox controller. The control device 1590 has three control mechanisms 1589 that are surrounded by a wall plate 1586. Control mechanism 1589-1 is an on/off (e.g., dipole) switch that controls whether power is delivered to the power supply (e.g., power supply 140) of an electrical device (e.g., electrical device 102-1), without affecting whether power continues to flow to the sound-controlled system (e.g., sound-controlled system 170).

Control mechanism 1589-2 of the control device 1590 of FIG. 15 is a dimmer that controls the amount of power, within a range of values, that is delivered to the power supply (e.g., power supply 140) of an electrical device (e.g., electrical device 102-1), without affecting the amount of power delivered to the sound-controlled system (e.g., sound-controlled system 170). Control mechanism 1589-3 is a toggle switch that, when operated in a specific sequence (multiple changes of positions), instructs a sound-controlled system (e.g., sound-controlled system 170) to take some action. Examples of such an action can include, but is not limited to, resetting itself, muting itself, and changing a setting.

FIG. 16 shows a system diagram 1600 of in accordance with certain example embodiments. Referring to FIGS. 1-16, the system 1600 of FIG. 16 includes a user 1650, an electrical device 1602-1, a back-end system 1659, a network manager 1680, and optionally at least one other electrical device 1602-N. The user 1650, the electrical device 1602-1, the optional other electrical devices 1602-N, and the network manager 1680 are substantially the same as the corresponding components described above with respect to FIG. 1.

The back-end system 1659 is configured to supplement and enhance the performance of the sound-controlled system 1670. For example, some of the functions of the control engine 106 and the storage repository 130 discussed above with respect to the sound-controlled system 170 of FIG. 1 above can reside on and be performed by the back-end system 1659. As a specific example, the back-end system 1659 can receive a digital audio file of the sound or series of sounds (e.g., speech) received from the user 1650. Upon receiving this audio file, the back-end system 1659 can analyze the file by determining the words spoken by the user 1650 and understanding the meaning of the words spoken by the user 1650.

Once the words spoken by the user 1650 are understood by the back-end system 1659, the back-end system 1659 can respond to the question, command, instruction, or other words spoken by the user 1650. For example, if the user 1650 is asking what the weather is going to be like that day, the back-end system 1659 can research and retrieve the local weather forecast (e.g., from a weather web site, from a website for a local news station), and send the forecast to the sound-controlled system 1670, which can digitally speak the forecast to the user 1650 through a speaker (a type of audio component 175 described above with respect to FIG. 1) of the sound-controlled system 1670.

There are a number of different communication links 1605 shown in the system 1600 of FIG. 16. These communication links 1605 can be substantially the same as the communication links 105 described above with respect to FIG. 1. The user 1650 is coupled to the sound-controlled system 1670 of the electrical device 1602-1 using communication link 1605-1, which allow, for example, for the transfer of spoken words between the user 1650 and the sound-controlled system 1670 of the electrical device 1602-1.

The communication link 1605-2 used to couple the sound-controlled system 1670 of the electrical device 1602-1 to the back-end system 1659 can include WiFi. Similarly, the communication link 1605-3 used to couple the back-end system 1659 to the network manager 1680 can include WiFi. The communication link 1605-4 used to couple the network manager 1680 to the power supply 1640 and/or the electrical device components 1642 of the electrical device 1602-1. Optionally, the communication link 1605-4 used to couple the network manager 1680 to one or more of the other electrical devices 1602-N can also include Bluetooth or some variation thereof (e.g., BLE). In such a case, the communication network between the network manager 1680, electrical device 1602-1, and the other electrical devices 1602-N can be in any of a number of configurations, including but not limited to a mesh network.

Alternatively, if the functionality of the back-end system 1659 is incorporated into the sound-controlled system 1670 of the electrical device 1602-1, then any command on instruction given by the user 1650 that affects the operation of one or more of the electrical devices 1602 in the system 1600 can be directly controlled by the sound-controlled system 1670 using wired communication and/or wireless (e.g., BLE) communication.

In addition, all of the electrical devices 1602 in the system 1600 can be substantially similar to each other (e.g., light fixtures) and/or part of the same system (e.g., a lighting system). Alternatively, the electrical devices 1602 in the system 1600 can be different from each other (e.g., light fixture, security camera, coffee maker, clock, thermostat) and/or part of multiple systems (e.g., a lighting system, security system, A/V system, HVAC system).

Example embodiments can also be used for one or more other purposes. For instance, commissioning of one or more electrical devices 1602 (or portions thereof) can be performed using example embodiments. As a specific example, if electrical device 1602-1 is newly installed, the electrical device 1602-1 needs to be commissioned into the system 1600. Commissioning is a quality assurance process that ensures installed building systems perform interactively and continuously according to owner needs and the design intent.

This commissioning process can occur in any of a number of ways. For example, the user 1650 can have a user system (e.g., a cell phone) that includes an app that is specifically configured to commission the electrical device 1602-1 and its various components. If the electrical device 1602-1 includes a light fixture, and if the sound-controlled system 1670 of the electrical device 1602-1 includes two speakers and two microphones (all forms of audio components, such as audio components 175 of FIG. 1), then the light fixture, both speakers, and both microphones can be commissioned by the user 1650 through the app on the user system using communication link 1605-1.

As another example, if the electrical device 1602-1 is added to a system 1600 in which the other electrical devices 1602-N are already commissioned and operating, then the electrical device 1602-1 and its various components can automatically be commissioned by the network manager 1680 and/or one or more of the other electrical devices 1602-N that are in direct or indirect communication with the electrical device 1602-1 using one or more of the communication links 1605 (e.g., communication link 1605-4).

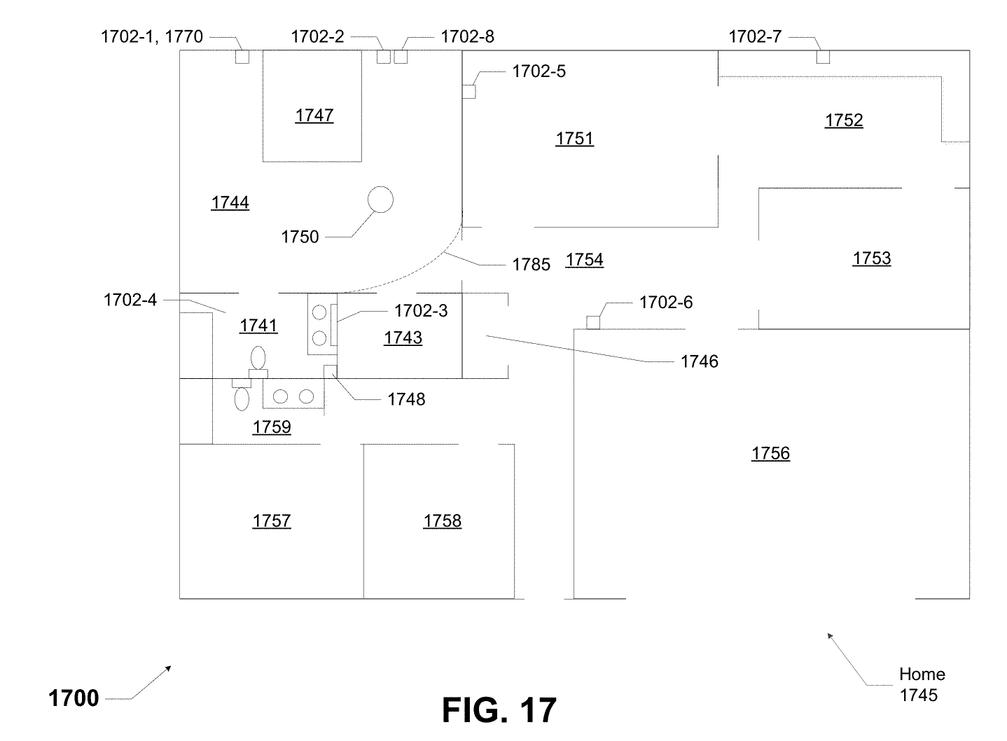

FIG. 17 shows a system in which one or more electrical devices 1702 in accordance with certain example embodiments can be used. Specifically, FIG. 17 shows an example of how the system 1600 of FIG. 16 can be implemented. Referring to FIGS. 1 through 17, the system 1700 of FIG. 17 is set throughout a home 1745. The home 1745 includes a family room 1751, a kitchen 1752, a dining room 1753, a hallway/entryway 1754, garage 1756, a spare bedroom 1757, another spare bedroom 1758, a secondary bathroom 1759, a laundry room 1746, and a master bedroom 1744 having a master bathroom 1741 and a master closet 1743. A bed 1747 is shown in the master bedroom 1744, and a speaker 1748 is shown in the master bathroom 1741. Other furniture, appliances, and features of the home 1745 are not shown in FIG. 17 for simplicity.

There are also a number of electrical devices 1702 positioned throughout the home 1745. For example, as shown in FIG. 17, electrical device 1702-1 and electrical device 1702-2, both in the form of table lamps, are located on either side of the bed 1747 in the master bedroom 1744. In the master bathroom 1741, there is an electrical device 1702-3 in the form of a light fixture, an electrical device 1702-4 in the form of a floor heating system, and an electrical device 1702-8 in the form of a digital clock. In the family room 1751, there is an electrical device 1702-5 in the form of a stereo, which is connected to the speaker 1748 in the master bathroom 1741. In the hallway 1754, there is an electrical device 1702-6 in the form of a thermostat , which controls the HVAC system in the home 1745. Finally, in the kitchen 1752, there is an electrical device 1702-7 in the form of a coffee maker. Other electrical devices are also disposed throughout the home 1745 but are not shown in FIG. 17 for simplicity.

In this example, electrical device 1702-1 (one of the table lamps in the master bedroom 1744) is substantially similar to electrical device 102-1 of FIG. 1. Specifically, electrical device 1702-1 includes a sound-controlled system 1770, substantially similar to the sound-controlled system 170 of FIG. 1. The remaining electrical devices 1702 shown in FIG. 17 (specifically, electrical device 1702-2, electrical device 1702-3, electrical device 1702-4, electrical device 1702-5, electrical device 1702-6, electrical device 1702-7, and electrical device 1702-8) are substantially similar to the other electrical device 102-N of FIG. 1. In particular, these remaining electrical devices 1702 (electrical device 1702-2, electrical device 1702-3, electrical device 1702-4, electrical device 1702-5, electrical device 1702-6, electrical device 1702-7, and electrical device 1702-8) do not include a sound-controlled system 1770, but they do include a controller (e.g., controller 104 of FIG. 1) that allows for communication among the electrical devices 1702 in the system 1700.

In this example, a user 1750, when within the communication range 1785 of the transceiver (e.g., transceiver 124) of the controller (e.g., controller 104) of the sound-controlled system 1770 of electrical device 1702-1, can speak a command, request or question. In such a case, the sound-controlled system 1770 receives the words spoken by the user 1750, and provides an appropriate response to those spoken words. In some cases, as described above with respect to FIG. 16, the appropriate response can involve the control of one or more other electrical devices 1602-N.

As a specific example, the user 1750 is in the master bedroom 1744 at 7:45 p.m. on a Wednesday and states: “Light fixture, set the alarm for 5:25 tomorrow morning.” Since the user 1750 is within the communication range 1785 of the transceiver of the sound-controlled system 1750 of the electrical device 1702-1, the control engine (e.g., control engine 106) of the sound-controlled system 1750 receives and determines the content of the spoken statement (a form of communication link 1605-1). In direct response to the command in the statement spoken by the user 1750, the sound-controlled system 1770 communicates (using a communication link that can include, for example, BLE) with electrical device 1702-8 to instruct the digital clock in the master bedroom 1744 to set an alarm for 5:25 the following morning.

Based on one or more of a number of factors (e.g., usage and behavioral history of the user 1750, preferences provided by the user 1750), the controller of the sound-controlled system 1770 can enhance the operation of electrical device 1702-8 and/or integrate the operation of one or more of the other electrical devices 1702 in the system 1700 as a result of the command given by the user 1750. For example, the controller of the sound-controlled system 1770 can know, based on history and/or user preferences, that the user 1750 prefers to have the alarm sound as a string instrument version of Canon in D Major by Johann Pachelbel, playing in a continuous loop, starting at a volume level of 1 (out of 10), and gradually increase linearly in sound for 15 minutes to a volume level of 8, and maintaining that volume level thereafter until the user 1750 turns off the alarm. As a result, the controller of the sound-controlled system 1770 can send these instructions to electrical device 1702-8 along with having the alarm begin at 5:25 in the morning.

As another example, the controller of the sound-controlled system 1770 can know, based on history and/or user preferences, that the user 1750 prefers to have all of the lights in the master bedroom 1744 and the master bathroom 1741 turn on with a dimmed, soft blue light for the first 25 minutes of being awake, and then changing to bright white light thereafter until the light fixtures are manually turned off by the user 1750. As a result, the controller of the sound-controlled system 1770 can send these instructions to electrical device 1702-2 in the master bedroom 1744 and to electrical device 1702-3 in the master bathroom using one or more communication links (e.g., communication links 105). Also, since the sound-controlled system 1770 is integrated with electrical device 1702-1, the controller of the sound-controlled system 1770 can control the light source (a form of electrical device component, such as electrical device component 142 in FIG. 1) in a manner consistent with those instructions.

As still another example, the controller of the sound-controlled system 1770 can know, based on history and/or user preferences, that if the outside temperature is below 55° F., the user 1750 prefers to have the floor in the master bathroom 1741 heated when the user 1750 is taking a shower and performing other actions in the master bathroom 1741, and that the user 1750 typically spends 20 minutes in the master bathroom 1741 starting 5 minutes after the user 1750 is awake in the morning. The controller of the sound-controlled system 1770 can also know, based on history and/or user preferences, that the user 1750 prefers to listen to a local radio talk show that airs from 5:30 to 9:00 each weekday morning on 770AM. As a result, the controller of the sound-controlled system 1770 can send these instructions to electrical device 1702-3 in the master bathroom 1741 and electrical device 1702-5 (which is communicably coupled to the speaker 1748 in the master bathroom 1741) in the family room 1751 using one or more communication links (e.g., communication links 105).

As still another example, the controller of the sound-controlled system 1770 can know, based on history and/or user preferences, that if the outside temperature is below 55° F., the user 1750 prefers to have the thermostat (in this case, electrical device 1702-6) set for 72° F. before the user 1750 leaves for work in the morning. As a result, the controller of the sound-controlled system 1770 can send these instructions at 5:35 a.m. to adjust the setting of electrical device 1702-6 in the hallway 1754 to 72° F. using one or more communication links (e.g., communication links 105).

As yet another example, the controller of the sound-controlled system 1770 can know, based on history and/or user preferences, that the user 1750 prefers to have a cup of coffee about 30 minutes after the user 1750 gets up. As a result, the controller of the sound-controlled system 1770 can send instructions to start electrical device 1702-6 in the kitchen 1752 at 5:50 a.m. using one or more communication links (e.g., communication links 105).

In certain example embodiments, as discussed above with respect to FIG. 16, once the sound-controlled system 1770 of electrical device 1702-1 has received the verbal command from the user 1750, the sound-controlled system 1770 of electrical device 1702-1 can communicate, using communication links (e.g., the Internet), with a back-end system (e.g., back-end system 1659) to determine the contents of the command, interpret those contents, and determine the actions that should be taken to satisfy the command.

The back-end system can then communicate, using communication links (e.g., the Internet), with the network manager (e.g., network manager 1680) to provide the actions needed to satisfy the command of the user 1750. The network manager can then communicate, using communication links (e.g., BLE), with one or more of the electrical devices 1702 in the system 1700 so that those electrical devices 1702 at the appropriate time and in the appropriate fashion to conform, directly or indirectly, with the instructions verbalized by the user 1750.

Example embodiments can be used in any of a number of other applications along the lines of what is described in FIG. 17. For example, if a user (e.g., user 150) is watching a movie at home, and if a nearby electrical device (e.g., a light fixture, a television, a DVD player) includes an example sound-controlled system (e.g., sound-controlled system 170), the sound-controlled system (in some cases with the assistance of a back-end system (e.g., back-end system 1659)) can determine what movie is playing as well as the current point in the movie. In such a case, the sound-controlled system and/or the back-end system can communicate with a network manager (e.g., network manager 180) to control one or more light fixtures in the room in which the movie is being watched to provide appropriate mood lighting that coincides with the various scenes of the movie in real time.

Example embodiments can incorporate one or more sound-controlled systems, including one or more audio components, into one or more electrical devices. In the simplest form of an example embodiment, an electrical device would have integrated therewith a sound-controlled system, which includes at least one speaker and at least one microphone, or at least a portion thereof. Example embodiments can also be used in a network of communicably interconnected electrical devices, where each electrical device could include at least one audio component (e.g., a microphone), and at least one of the electrical devices in the system would not include a sound-controlled system.

These other electrical devices can be of the same type as the electrical device in which a sound-controlled system is integrated, or at least one of them can be of different types. When some of the other electrical devices are of a different type compared to the type of electrical device in which the example sound-controlled system is integrated, all of those devices can be part of the same system or different systems, Example embodiments can include or be associated with a back-end system to help perform the functions of the voice-controlled system.

In some cases, example embodiments can control, based on user preferences that are expressed or observed/learned over time, one or more electrical devices that are collateral or complementary to an instruction expressed by a user. In this way, example embodiments can anticipate certain needs of the user by controlling these electrical devices. Example embodiments can be used to commission all or part of one or more electrical devices in a new or existing system.

Also, in certain example embodiments, an electrical device into which a sound-controlled system is integrated can be remotely controlled, as by a wall switch or an app on a mobile device. In such a case, such a remote control can be configured in such a way as to only control the principal operation of the electrical device, without affecting the operation of the sound-controlled system that is integrated into the electrical device. In this way, the sound-controlled system can always be active. In some cases, certain operational commands (e.g., reset) can be transmitted from a remote control to the sound-controlled system using a code, a sequence, or other form of communication that is understood by the sound-controlled system to be a specific command.

Accordingly, many modifications and other embodiments set forth herein will come to mind to one skilled in the art to which example embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A system comprising:
a first electrical device comprising:
at least one electrical device component used to operate the first electrical device to perform a function for which the first electrical device is designed to perform;
a sound-controlled system integrated with the first electrical device, wherein the sound-controlled system comprises:
at least one first audio component integrated with the first electrical device; and
a controller communicably coupled to the at least one first audio component;
a network manager communicably coupled to the sound-controlled system; and
at least one second electrical device coupled to the network manager,
wherein the at least one first audio component captures a first sound,
wherein the at least one first audio component sends the first sound to the controller, wherein the first sound, when received by the controller, enables the first controller,
wherein the controller is enabled independent of the function performed by at least one electrical device component,
wherein the controller sends, using a first communication mode, the first sound to the network manager, and
wherein the network manager controls the at least one second electrical device based on the first sound.

2. The system of claim 1, further comprising:
a back-end system communicably coupled to the sound-controlled system and the network manager, wherein the back-end system processes the first sound to determine instructions for the network manager, wherein the back-end system sends the instructions to the network manager.

3. The system of claim 2, wherein the back-end system sends the instruction using the first communication mode.

4. The system of claim 3, wherein the network manager controls the at least one second electrical device using a second communication mode.

5. The system of claim 4, wherein the first communication mode comprises WiFi, and wherein the second communication mode comprises Bluetooth Low Energy.

6. The system of claim 4, wherein the at least one electrical device component is communicably coupled to the network manager using the second communication mode.

7. The system of claim 1, wherein the at least one first audio component comprises at least one microphone and at least one speaker.

8. The system of claim 1, wherein the at least one electrical device component and the at least one first audio component are commissioned upon installation of the first electrical device.

9. The system of claim 1, wherein the first electrical device is part of a first electrical system, and wherein the at least one second electrical device is part of a second electrical system.

10. The system of claim 9, wherein the first electrical device comprises a light fixture, and wherein the first electrical system comprises a lighting system.

11. The system of claim 1, wherein the at least one first audio component is disposed in a trim of the first electrical device.

12. A system comprising:
an electrical device comprising:
at least one electrical device component used to operate the electrical device to perform a function for which the electrical device is designed to perform;
a sound-controlled system integrated with the electrical device, wherein the sound-controlled system comprises:
at least one audio component integrated with the electrical device; and
a controller communicably coupled to the at least one audio component; and
a control device coupled to the electrical device, wherein the control device comprises a first control mechanism, wherein operating the first control mechanism controls the function performed by the at least one electrical device without affecting operation of the sound-controlled system.

13. The system of claim 12, wherein the control device further comprises a second control mechanism, wherein operating the second control mechanism controls the sound-controlled system without affecting the function performed by the at least one electrical device.

14. The system of claim 13 wherein the second control mechanism, when operated in a sequence, resets the sound-controlled system.

15. The system of claim 12, wherein the first control mechanism comprises a first switch, and wherein the second control mechanism comprises a second switch.

16. A control device comprising:
a first control mechanism having at least two positions, wherein the first control mechanism is configured to be coupled to at least one first electrical device component of an electrical device, wherein the at least one first electrical device component is used to perform a first function for which the electrical device is designed to perform,
wherein the electrical device, when coupled to the first control mechanism, further comprises at least one second electrical device component that performs a second function that is unrelated to the first function,
wherein operating the first control mechanism between the at least two positions controls the first function performed by the at least one first electrical device component without affecting the second function performed by the at least one second electrical device component.

17. The control device of claim 16, further comprising:
a second control mechanism configured to be coupled to the at least one second electrical device component, wherein operating the second control mechanism controls the second function performed by the at least one second electrical device component without affecting the first function performed by the at least one first electrical device component.

18. The control device of claim 17, wherein operating the second control mechanism comprises a particular sequence of positions of the second control mechanism.

19. The control device of claim 17, further comprising:
a housing to which the first control mechanism is coupled, wherein the housing is configured to be disposed within an aperture in a wall.

20. The control device of claim 16, wherein the first control mechanism is operated by manipulating at least one feature on an app.
